(19) United States
(12) Patent Application Publication
(10) Pub. No.: US 2025/0273745 A1
(43) Pub. Date: Aug. 28, 2025

(54) ALL-SOLID-STATE SECONDARY BATTERY, ALL-SOLID-STATE SECONDARY BATTERY STRUCTURE, AND METHOD FOR MANUFACTURING ALL-SOLID-STATE SECONDARY BATTERY

(71) Applicant: Samsung SDI Co., Ltd., Yongin-si, Gyeonggi-do (KR)

(72) Inventors: Minsuk Lee, Yongin-si (KR); Younggyoon Ryu, Yongin-si (KR); Suyeol Ryu, Yongin-si (KR); Jaegu Yoon, Yongin-si (KR); Hongjeong Kim, Yongin-si (KR)

(21) Appl. No.: 18/857,972

(22) PCT Filed: Apr. 21, 2023
(86) PCT No.: PCT/KR2023/005497

§ 371 Date: Oct. 18, 2024

(30) Foreign Application Priority Data
Apr. 21, 2022 (KR) 10-2022-0049542

(51) Int. Cl. H01M 10/0585; H01M 10/052; H01M 10/0562; H01M 50/586

(52) U.S. Cl. CPC H01M 10/0585; H01M 10/052; H01M 10/0562; H01M 50/586

(57) ABSTRACT

Provided are an all-solid secondary battery, an all-solid secondary battery structure, and a method for manufacturing an all-solid secondary battery, the battery comprising a positive electrode layer, a negative electrode layer, and a solid electrolyte layer interposed between the positive electrode layer and the negative electrode layer, wherein the positive electrode layer includes a positive electrode current collector and a positive electrode active material layer disposed on one or both surfaces of the positive electrode current collector, and the negative electrode layer includes a negative electrode current collector and a first negative electrode active material layer disposed on the negative electrode current collector, the battery including an inactive member disposed to surround a side of the positive electrode layer, wherein the inactive member includes a position determination part configured to determine a position of the inactive member on the solid electrolyte layer.

### TECHNICAL FIELD

The present disclosure relates to an all-solid secondary battery, an all-solid secondary battery structure, and a method of manufacturing an all-solid secondary battery.

### BACKGROUND ART

Recent industrial demand has led to active development of batteries with high energy density and safety. For example, lithium-ion batteries are being put into practical use not only in the fields of information-related devices and communication devices, but also in the automotive filed. In the automotive field, safety is particularly important due to its relation to human life.

Lithium-ion batteries currently commercially available use an electrolyte that includes a flammable organic solvent, which poses a risk of overheating and fire in the event of a short circuit. To address this, all-solid batteries using solid electrolytes instead of liquid electrolytes have been proposed.

All-solid batteries do not use flammable organic solvents, which significantly reduces the risk of fire or explosion even if a short circuit occurs. Therefore, such all-solid batteries may offer significantly enhanced safety compared to lithium-ion batteries that use liquid electrolytes.

### DISCLOSURE

### Technical Problem

An aspect of the present disclosure is to provide a new structure of all solid secondary batteries.

An aspect of the present disclosure is to provide a new structure of all solid secondary battery structures.

Another aspect of the present disclosure is to provide a method for manufacturing a new structure of all solid secondary batteries.

### Technical Solution

According to an embodiment, provided is an all solid secondary battery, including
a positive electrode layer, a negative electrode layer, and a solid electrolyte layer interposed between the positive electrode layer and the negative electrode layer,
wherein the positive electrode layer includes a positive electrode current collector and a positive electrode active material layer disposed on one or both surfaces of the positive electrode current collector, and
the negative electrode layer includes a negative electrode current collector, and a first negative electrode active material layer disposed on the negative electrode current collector,
the battery further comprising an inactive member disposed to surround the side of the positive electrode layer,
wherein the inactive member includes a position determination part configured to determine the position of the inactive member on the solid electrolyte layer.

According to another embodiment, provided is an all solid secondary battery structure, including
one of more of all solid secondary batteries, and
a buffering member disposed on one or both surfaces of the one or more of the all solid secondary batteries.

According to another embodiment, provided is a method for manufacturing an all solid secondary battery, including
providing a first assembly including a solid electrolyte layer disposed on a negative electrode layer;
preparing a second assembly by aligning an inactive member reel in which a plurality of inactive members including a position determination part are connected on the solid electrolyte layer;
preparing a third assembly by cutting an uncoated part included in the negative electrode layer with reference to the position determination part of the inactive member reel;
preparing a fourth assembly including one inactive member by cutting the third assembly with reference to the position determination part of the inactive member; and
disposing the fourth assembly on one or both surfaces of the positive electrode layer such that the inactive member surrounds the side of the positive electrode layer.

### Advantageous Effects

In one aspect, the new structure of the all solid secondary battery, by having position determination parts on the inactive members, enables the easy manufacturing of all solid secondary batteries that prevent short circuits and exhibit improved cycle characteristics.

### DESCRIPTION OF DRAWINGS

FIG. 1 is a schematic diagram of an all solid secondary battery according to an exemplary embodiment. FIG. 1 partially shows the interior of an all-solid secondary battery.

FIG. 2 is an exploded view of the all-solid secondary battery of FIG. 1.

FIG. 3 is a plan view of a negative electrode layer/solid electrolyte layer/inactive member laminate before a positive electrode layer is disposed in a process of manufacturing the all-solid secondary battery of FIG. 1.

FIG. 4 is a plan view of an all-solid secondary battery according to an exemplary embodiment.

FIG. 5 is a cross-sectional view of an all-solid secondary battery according to an exemplary embodiment.

FIG. 6 is a schematic diagram of a bi-cell all-solid secondary battery according to an exemplary embodiment FIG. 7 is a cross-sectional view of a bi-cell all-solid secondary battery according to an exemplary embodiment.

FIG. 8 is a cross-sectional view of a mono-cell all-solid secondary battery structure according to an exemplary embodiment.

FIG. 9 is a cross-sectional view of a bi-cell all-solid secondary battery structure according to an exemplary embodiment.

FIG. 10 is a cross-sectional view of an all-solid secondary battery structure according to an exemplary embodiment.

### BEST MODE

Since the electrolyte in all solid secondary batteries is solid, if sufficient contact between the positive electrode layer and the solid electrolyte layer, as well as between the negative electrode layer and the solid electrolyte layer, is not maintained, the resistance within the battery increases, making it difficult to achieve excellent battery performance.

In order to increase the contact between the negative electrode layer and the solid electrolyte, a pressurization process is applied during the manufacturing process of the all solid secondary battery. During the pressurization process, pressure differences occur in some unlaminated parts of the laminate including the positive electrode layer, the negative electrode layer, and the solid electrolyte layer, and these pressure differences cause micro-defects in the solid electrolyte layer. During the charge-discharge cycles of the all solid secondary battery, these defects lead to the formation and growth of cracks within the solid electrolyte layer. Through these cracks, lithium grows, causing short circuits between the positive electrode layer and negative electrode layer.

The all solid secondary battery according to an aspect has a new structure that prevents short circuits during charge-discharge cycles, improves cycle characteristics, and enhances the ease of manufacturing the all solid secondary battery.

The present inventive concept described below may undergo various modifications and may have several embodiments, and specific embodiments are illustrated in the drawings and described in detail. However, this is not intended to limit the present inventive concept to the specific embodiments, and it should be understood that all modifications, equivalents, or alternatives included within the scope of the technical concept of the present inventive concept are included.

The terms used herein are only for the purpose of describing particular embodiments and are not intended to limit the present inventive concept. Singular expressions include plural expressions unless the context clearly indicates otherwise. Hereinafter, it should be understood that terms such as “comprising” or “having” are intended to indicate the presence of features, numbers, steps, operations, components, parts, ingredients, materials, or combinations thereof described in the specification, but are not intended to preclude the possibility of the presence or addition of one or more of other features, numbers, steps, operations, components, parts, ingredients, materials, or combinations thereof. The “/” used herein may be interpreted as “and” or “or” depending on the context.

In order to clearly express various layers and regions in the drawing, thickness have been exaggerated or reduced. Similar parts throughout the specification are denoted by the same reference numerals. Throughout the specification, when a layer, film, area, plate, or the like is described as being “on” or “above” another part, it includes both cases where it is directly on top of the other part and cases where another part is interposed between them. Terms like first, second, and so on may be used to describe various components but should not be limited by these terms. Terms are used only to distinguish one component from another. Throughout the specification and drawings, components with substantially the same function and configuration are denoted by the same reference numerals to avoid redundant descriptions.

Hereinafter, all solid secondary batteries according to example embodiments will be described in more detail

### [All Solid Secondary Battery]

An all solid secondary battery according to an embodiment includes a positive electrode layer, a negative electrode layer, and a solid electrolyte layer interposed between the positive electrode layer and the negative electrode layer, wherein the positive electrode layer includes a positive electrode current collector and a positive electrode active material layer disposed on one or both surfaces of the positive electrode current collector, and the negative electrode layer includes a negative electrode current collector and a first negative electrode active material layer disposed on the negative electrode current collector, and the battery includes an inactive member disposed to surround the side of the positive electrode layer, wherein the inactive member includes a position determination part configured to determine the position of the inactive member on the solid electrolyte layer.

The inclusion of a position determination part in the inactive member facilitates the alignment of the inactive member on the solid electrolyte layer during the manufacturing of the all solid secondary battery. After the inactive member is placed on the solid electrolyte layer, the alignment of the positive electrode layer on the solid electrolyte layer on which the inactive member is disposed becomes easier. Thus, the sequential placement of the inactive member and the positive electrode layer on the solid electrolyte layer is facilitated, improving the overall ease of manufacturing of all solid secondary battery.

Additionally, by disposing an inactive member surrounding the side of the positive electrode layer, the occurrence of cracks in the solid electrolyte layer during pressurization and/or charge-discharge cycles of all solid secondary battery is suppressed. Therefore, cracks in the solid electrolyte layer is suppressed during charge-discharge cycles of the all solid secondary battery, and thereby, short-circuits in the all solid secondary battery is suppressed. Moreover, the internal resistance of the all solid secondary battery is reduced, increasing the discharge capacity during high-rate discharge. As a result, the cycle characteristics of the all solid secondary battery are improved.

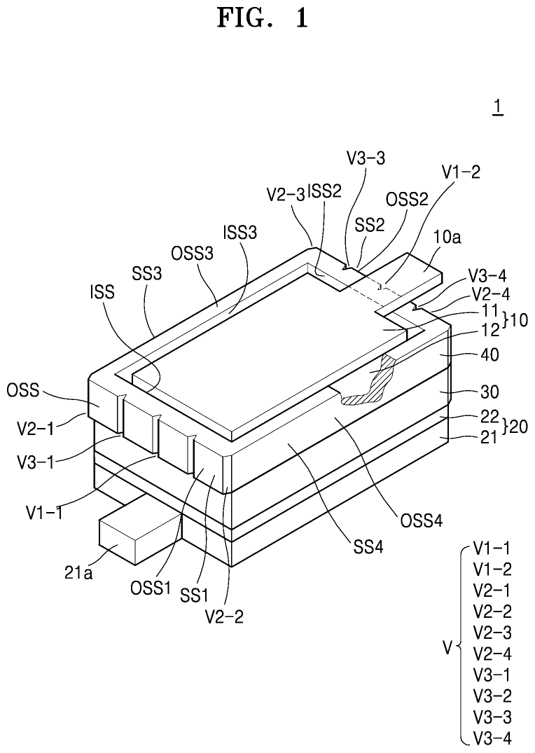

Referring to FIGS. 1 to 6, the all solid secondary battery 1 includes a positive electrode layer 10, a negative electrode layer 20, and a solid electrolyte layer 30 interposed between the positive electrode layer 10 and the negative electrode layer 20, wherein the positive electrode layer 10 includes a positive electrode current collector 11 and a positive electrode active material layer 12 disposed on one or both surfaces of the positive electrode current collector, the negative electrode layer 20 includes a negative electrode current collector 21 and a first negative electrode active material layer 22 disposed on the negative electrode current collector, and the battery includes an inactive member 40 disposed to surround the side of the positive electrode layer 10, wherein the inactive member 40 includes a position determination part V configured to determine the position of the inactive member 40 on the solid electrolyte layer 30.

### [Positive Electrode Layer]

### [Positive Electrode Layer: Flame-Retardant Inactive Material]

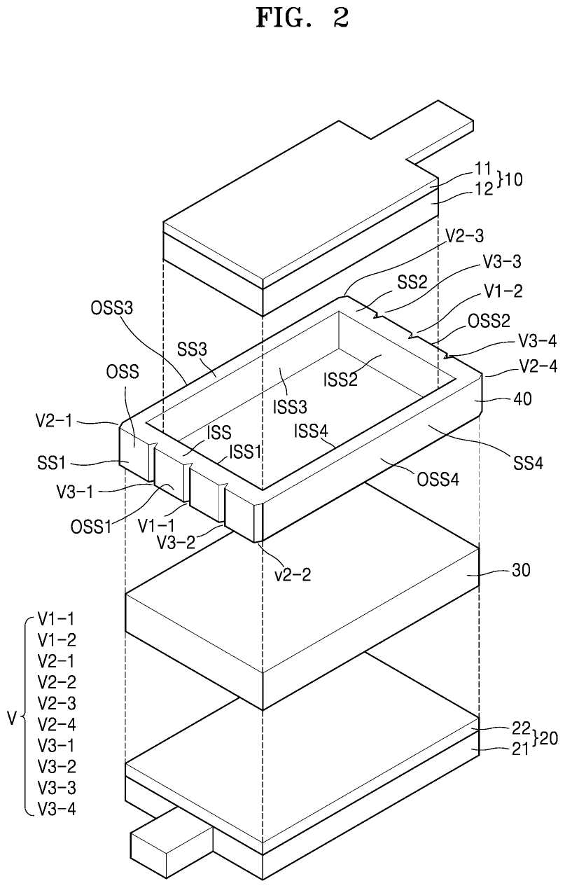

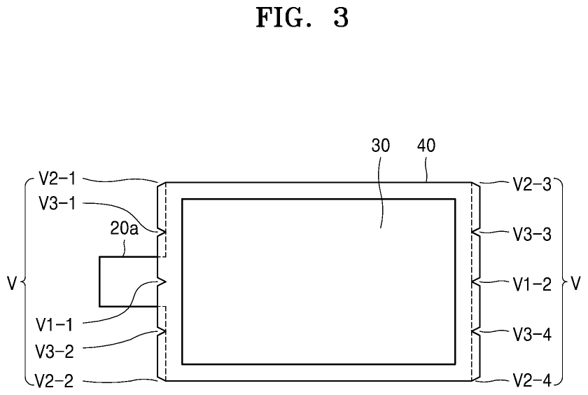

FIG. 1 is a schematic diagram of an all solid secondary battery according to an exemplary embodiment. FIG. 1 partially shows the interior of an all solid secondary battery. FIG. 2 is an exploded view of the all solid secondary battery of FIG. 1. FIG. 3 is a plan view of the negative electrode layer/solid electrolyte layer/inactive member laminate before the positive electrode layer is disposed in the manufacturing process of the all solid secondary battery of FIG. 1.

Referring to FIGS. 1 to 3, the positive electrode layer 10 includes a positive electrode current collector 11 and a positive electrode active material layer 12 disposed on one surface of the positive electrode active material layer 11. An inactive member 40 is disposed on one side of the positive electrode layer 10. The inactive member 40 is disposed to surround the side of the positive electrode layer 10. The inactive member 40 includes a position determination part V for determining the position of the inactive member 40 on the solid electrolyte layer 30. The inclusion of the position determination part V in the inactive member 40 allows the inactive member to be easily aligned on the solid electrolyte layer 30. Therefore, the all solid secondary battery 1 including the inactive member 40 may be easily manufactured. The alignment of the inactive member 40 in the intended position on the solid electrolyte layer 30 improves the uniformity of the manufactured all solid secondary battery 1. In the all solid secondary battery 1 without the position determination part V on the solid electrolyte layer 30, the inactive member 40 and/or the positive electrode layer 10 may not be aligned in the intended position.

Therefore, the possibility of defects such as cracks occurring during the battery manufacturing process increases, and as a result, defects in the all solid secondary battery 1 may increase. The all solid secondary battery 1 having this defect may deteriorate cycle characteristics.

Referring to FIGS. 1 to 3, the inactive member 40 includes a first side SS1, a second side SS2 opposite the first side SS1, a third side SS3 disposed between the first side SS1 and the second side SS2, and a fourth side SS4 opposite the third side SS3, and a position determination part V includes a position determination part 1-1 (V1-1) disposed on the first side SS1. The positive electrode layer 11 includes a positive electrode uncoated part 11a extending outward from one side of the positive electrode layer 10, and the negative electrode current collector 21 includes a negative electrode uncoated part 21a extending outward from one side of the negative electrode layer 20, and the position determination part 1-1 (V1-1) is disposed on the positive electrode uncoated part 11a or the negative electrode uncoated part 21a. By including the position determination part 1-1 (V1-1) in the inactive member 40, the position of the positive electrode uncoated part 11a or the negative electrode uncoated part 21a may be determined with reference to the position determination part 1-1 (V1-1). For example, in the manufacturing process of the all solid secondary battery 1, the positions of the positive electrode current collector 11 or the negative electrode current collector 21 may be selected by maintaining the positive electrode current collector 11 or the negative electrode current collector 21 as the positive electrode uncoated part 11a or the negative electrode uncoated part 21a in a certain area around the position determination part 1-1 (V1-1) and cutting the positive electrode current collector 11 or the negative electrode current collector 21 in the remaining area. The position determination part V further includes a position determination part 1-2 (V1-2) disposed on the second side SS2. The position determination part 1-2 (V1-2) is disposed symmetrically to the position determination part 1-1 (V1-1). The position determination part 1-2 (V1-2) is, for example, disposed on the positive electrode uncoated part 11a or the negative electrode uncoated part 21a.

Referring to FIGS. 1 to 3, the position determination part V further includes a position determination part 2-1 (V2-1) disposed in the area where the first side SS1 and the third side SS3 are connected, and a position determination part 2-2 (V2-2) disposed in the area where the first side SS1 and the fourth side SS4 are connected. The position determination part 2-1 (V2-1) and the position determination part 2-2 (V2-2) determine the length of the inactive member 40 in the machine direction MD or the transverse direction TD. Additionally, the position determination part V further includes a position determination part 2-3 (V2-3) disposed in the area where the second side SS2 and the third side SS3 are connected, and a position determination part 2-4 (V2-4) disposed in the area where the second side SS2 and the fourth side SS4 are connected. The position determination part 2-3 (V2-3) and the position determination part 2-4 (V2-4) determine the length of the inactive member 40 in the machine direction (MD) or the transverse direction (TD). By including one or more of the position determination part 2-1 (V2-1), the position determination part 2-2 (V2-2), the position determination part 2-3 (V2-3), and the position determination part 2-4 (V2-4) in the inactive member 40, the size and position of the inactive member 40 may be more easily determined. For example, an inactive member 40 of the size and shape shown in FIGS. 1 and 2 is obtained by cutting the section between the position determination part 2-1 (V2-1) and the position determination part 2-3 (V2-3), and the section between the position determination part 2-2 (V2-2) and the position determination part 2-4 (V2-4) from an inactive member reel where a plurality of inactive members 40 are connected. The position determination part 2-1 (V2-1), position determination part 2-2 (V2-2), position determination part 2-3 (V2-3), and position determination part 2-4 (V2-4) may have the same size and shape as other position determination parts V such as the position determination part 1-1 (V1-1) from the inactive member reel where a plurality of the inactive members 40 are connected, but may also have different sizes and shapes due to the aforementioned cutting.

Referring to FIGS. 1 to 3, the position determination part V further includes a position determination part 3-1 (V3-1) and a position determination part 3-2 (V3-2) disposed on the first side SS1. The position determination part 3-1 (V3-1) is disposed on the first side SS1, between the position determination part 1-1 (V1-1) and the third side SS3, while the position determination part 3-2 (V3-2) is disposed on the first side SS1, between the position determination part 1-1 (V1-1) and the fourth side SS4. For example, the position determination part 3-1 (V3-1) is disposed closer to the third side SS3 than is the position determination part 1-1 (V1-1). For example, the position determination part 3-2 (V3-2) is disposed closer to the fourth side SS4 than is the position determination part 1-1 (V1-1). In other words, the position determination part 3-1 (V3-1) is disposed between the position determination part 1-1 (V1-1) and the position determination part 2-1 (V2-1), while the position determination part 3-2 (V3-2) is disposed between the position determination part 1-1 (V1-1) and the position determination part 2-2 (V2-2). In addition, the position determination part 3-1 (V3-1) is disposed closer to the position determination part 2-1 (V2-1) than is the position determination part 1-1 (V1-1), and the position determination part 3-2 (V3-2) is disposed closer to the position determination part 2-2 (V2-2) than is the position determination part 1-1 (V1-1). By including the position determination part 3-1 (V3-1) and the position determination part 3-2 (V3-2) in the inactive member 40, the position of the inactive member 40 on the solid electrolyte layer 30 and the position of the positive electrode layer 10 within the inactive member 40 may be more easily determined. The position determination part V further includes a position determination part 3-3 (V3-3) and a position determination part 3-4 (V3-4) disposed on the second side SS2 The position determination part 3-3 (V3-3) is disposed between the position determination part 1-1 (V1-1) and the third side SS3, while the position determination part 3-4 (V3-4) is disposed between the position determination part 1-1 (V1-1) and the fourth side SS4. The position determination part 3-3 (V3-3) and the position determination part 3-4 (V3-4) are, for example, each disposed symmetrically to the position determination part 3-1 (V3-1) and the position determination part 3-2 (V3-2), respectively.

Referring to FIGS. 1 to 3, the specific position and shape of the position determination part V included in the inactive member 40 are not particularly limited and anything is possible, as long as they may serve the role of determining the position of the inactive member 40 during the manufacturing process of the all solid secondary battery. The position determination part V may be composed of the same material as the inactive member 40, and may be composed of a material that does not participate in electrochemical reactions or cause side reactions with lithium or the solid electrolyte. The position determination part V may not be a separate member added to the inactive member 40. The inactive member 40 includes an inner side ISS adjacent to the side of the positive electrode layer 10 and an outer side OSS opposite the inner side ISS, with the position determination part V disposed on the outer side OSS. Alternatively, the position determination part V may be disposed on the inner side ISS. The position determination part V, for example, includes a recessed part extending from the outer side OSS towards the inner side ISS. The recessed part may have a polygonal shape. A polygonal shape may include, for example, triangles, squares, pentagons, or any other shape that may serve the role of position determination, and is not limited to these examples. The position determination part V may be, for example, hemispherical. For example, the position determination part V may extend from the outer side OSS and/or the inner side ISS and may not be separated from the outer side OSS and/or the inner side ISS.

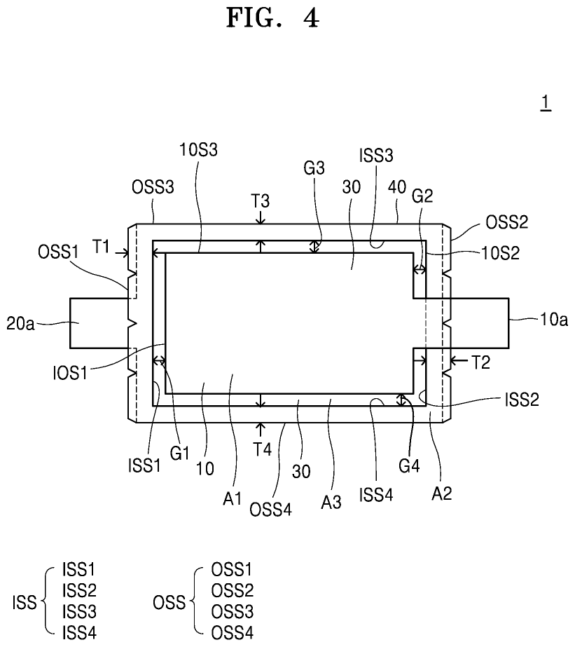

FIG. 4 is a plan view of an all solid secondary battery according to an exemplary embodiment.

Referring to FIGS. 1, 2, and 4, the inactive member 40 includes: a first inner side ISS1 adjacent to the first side 10S of the positive electrode layer 10 and a first outer side OSS1 opposite the first inner side ISS1, with a first distance T1 between the first inner side ISS1 and the first outer side OSS1; a second inner side ISS2 adjacent to the second side 1052 of the positive electrode layer 10 and a second outer side OSS2 opposite the second inner side ISS2, with a second distance T2 between the second inner side ISS2 and the second outer side OSS2; a third inner side ISS3 adjacent to the third side 1053 of the positive electrode layer 10 and a third outer side OSS3 opposite the third inner side ISS3, with a third distance T3 between the third inner side ISS3 and the third outer side OSS3; and a fourth inner side ISS4 adjacent to the fourth side 10S4 of the positive electrode layer 10 and a fourth outer side OSS4 opposite the fourth inner side ISS4, with a fourth distance T4 between the fourth inner side ISS4 and the fourth outer side OSS4. The first distance T1 and the second distance T2 may each independently be 1% to 20%, 1% to 15%, 1% to 10%, or 1% to 5% of the distance between the first outer side OSS1 and the second outer side OSS2. The third distance T3 and the fourth distance T4 may each independently be, for example, 1% to 30%, 1% to 25%, 1% to 20%, 1% to 15%, 1% to 10%, or 1% to 5% of the distance between the third outer side OSS3 and the fourth outer side OSS4. By having distances between the inner side and the outer side within these ranges, the inactive member 30 may provide an all solid secondary battery with excellent energy density and improved safety. If the distance between the inner side and the outer side of the inactive member 40 is too small, it may be difficult to effectively prevent the occurrence of cracks during the battery manufacturing process or short circuits during the charge-discharge cycles. If the distance between the inner side and the outer side of the inactive member 40 increases excessively, the energy density of the all solid secondary battery may decrease.

Referring to FIGS. 1, 2, and 4, the inactive member 40 and the positive electrode layer 10 may be at least partially spaced apart from each other. The inactive member 40 is disposed to surround the side of the positive electrode layer 10, and may be spaced apart from some or all of the sides of the positive electrode layer 10. Alternatively, the inactive member 40 may be disposed to surround the side of the positive electrode layer 10 and may be in contact with some or all of the sides of the positive electrode layer 20.

There is a first gap G1 between the first side 20S1 of the positive electrode layer 10 and the first inner side ISS1 of the inactive member 40, and the first gap G1 may be, for example, 1% to 99%, 1% to 90%, 1% to 50%, 1% to 30%, 2% to 20%, or 5% to 20% of the first distance T1. There is a second gap G2 between the second side 20S2 of the positive electrode layer 10 and the second inner side ISS2 of the inactive member 40, and the second gap G2 may be, for example, 1% to 99%, 1% to 90%, 1% to 50%, 1% to 30%, 2% to 20%, or 5% to 20% of the second distance T2. There is a third gap G3 between the third side 20S3 of the positive electrode layer 10 and the third inner side ISS3 of the inactive member 40, and the third gap G3 may be, for example, 1% to 99%, 1% to 90%, 1% to 50%, 1% to 30%, 2% to 20%, or 5% to 20% of the third distance T3. There is a fourth gap G4 between the fourth side 20S4 of the positive electrode layer 10 and the fourth inner side ISS4 of the inactive member 40, and the fourth gap G4 may be, for example, 1% to 99%, 1% to 90%, 1% to 50%, 1% to 30%, 2% to 20%, or 5% to 20% of the fourth distance T4. By having the inactive member 40 maintain these ranges of gaps with the positive electrode layer 10, the production speed of the all solid secondary battery may increase, and the ease of manufacture may improve.

Referring to FIGS. 1 to 4, the inactive member 40 is disposed on the surface of the solid electrolyte layer 30.

The first area defined by the first outer side OSS1 to the fourth outer side OSS4 of the inactive member 40 is larger than the area of the solid electrolyte layer 30 that contacts the inactive member 40. For example, the first area defined by the first outer side OSS1 to the fourth outer side OSS4 of the inactive member 40 is 101% to 150%, 101% to 130%, or 101% to 110% of the area of the solid electrolyte layer 30 that contacts the inactive member 40. By having the first area of the inactive member 40 within this range, lithium dendrites growing through cracks in the solid electrolyte layer and short circuits with the positive electrode may be effectively prevented.

The second area defined by the first inner side ISS1 to the fourth inner side ISS4 of the inactive member 40 is smaller than the area of the solid electrolyte layer 30 that contacts the inactive member 40. For example, the second area defined by the first inner side ISS1 to the fourth inner side ISS4 of the inactive member 40 is 50% to 99%, 70% to 99%, or 90% to 99% of the area of the solid electrolyte layer. By having the second area of the inactive member 40 within this range, the inactive member 40 may be easily disposed on the solid electrolyte layer 30.

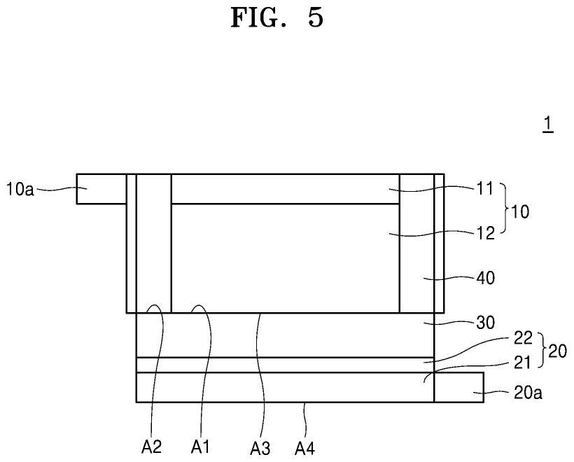

FIG. 5 is a cross-sectional view of an all solid secondary battery according to an exemplary embodiment.

Referring to FIGS. 4 and 5, the area A1 of the positive electrode layer 10 is smaller than the area A3 of the solid electrolyte layer 30 that contacts the positive electrode layer 10, and the inactive member 40 is disposed to surround the side of the positive electrode layer 10, compensating for some or all of the difference in area between the positive electrode layer 10 and the solid electrolyte layer 30. By compensating for some or all of the difference in area between the positive electrode layer 10 and the solid electrolyte layer 30 with the area A2 of the flame-retardant inactive member 40, cracks in the solid electrolyte layer 30 caused by pressure differences during the pressing process may be effectively suppressed. For example, the sum of the area A1 of the positive electrode layer 10 and the area A2 of the inactive member 40 may be 90% to 120%, 90% to 110%, 90% to 105%, 90% to 100% or 95% to 99% of the area A3 of the solid electrolyte layer 30.

The area A1 of the positive electrode layer 10 may be, for example, 80% to 99.9%, 85% to 99%, 90% to 99%, or 95% to 99% of the area A3 of the solid electrolyte layer 30. If the area A1 of the positive electrode layer 10 is equal to or larger than the area A3 of the solid electrolyte layer 30, there is an increased possibility of short circuits caused by physical contact between the positive electrode layer 10 and the first negative electrode active material layer 22 or by overcharging of lithium. The area A1 of the positive electrode layer 10 is, for example, the same as the area of the positive electrode active material layer 12.

The area A2 of the inactive member 40 may be 1% to 50%, 1% to 40%, 1% to 20%, 1% to 10%, or 1% to 5% of the area A1 of the positive electrode layer 10.

The area A1 of the positive electrode layer 10 is smaller than the area A4 of the first negative electrode active material layer 22. The area A1 of the positive electrode layer 10 may be, for example, 80% to 99.9%, 85% to 99%, 90% to 99%, or 95% to 99% of the area A4 of the first negative electrode active material layer 22.

The area of the negative electrode layer 20 is, for example, the same as the area A4 of the first negative electrode active material layer 22.

As used herein, “same” area, length, width, thickness and/or shape means “substantially the same” area, length, width, thickness and/or shape, except where the area, length, width, thickness and/or shape are intentionally made different. “Same” area, length, width, and/or thickness includes cases where unintended differences between the compared objects are, for example, less than 1%, less than 0.5%, or less than 0.1%.

The inactive member 40 may be, for example, a gasket. By using a gasket as the inactive member 40, cracks in the solid electrolyte layer 30 caused by pressure differences during the pressing process may be effectively suppressed.

The inactive member 40 may have, for example, a single-layer structure. Alternatively, although not shown in the drawings, the inactive member 40 may have a multilayer structure. In an inactive member 40 with a multilayer structure, each layer may have a different composition. The inactive member with a multilayer structure may have, for example, a two-layer structure, a three-layer structure, a four-layer structure, or a five-layer structure. The inactive member 40 with a multilayer structure may include, for example, one or more adhesive layers and one or more support layers. For example, the adhesive layer may effectively prevent separation between the positive electrode layer 10 and the solid electrolyte layer 30 caused by volume changes of the positive electrode layer 10 during the charge-discharge cycles of the all solid secondary battery 1, and improve the film strength of the inactive member 40 by providing adhesion between the support layer and other layers. The support layer provides support to the inactive member 40, prevents pressure irregularities on the solid electrolyte layer 30 during the pressurization process or the charge-discharge cycles, and prevents deformation of the manufactured all solid secondary battery 1.

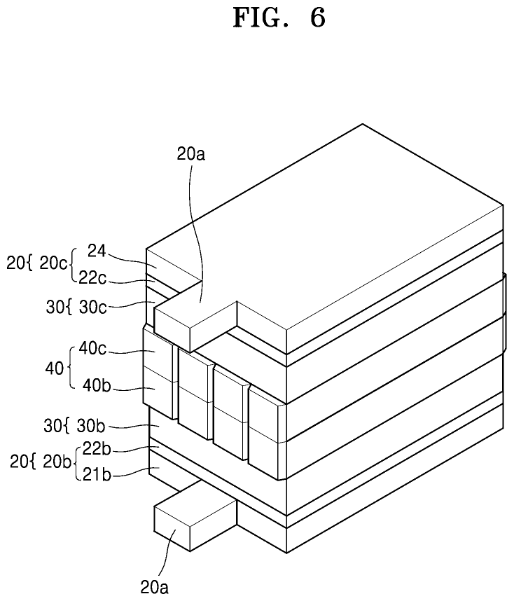

FIG. 6 is a schematic diagram of a bi-cell all solid secondary battery according to an exemplary embodiment. FIG. 7 is a cross-sectional view of a bi-cell all solid secondary battery according to an exemplary embodiment.

Referring to FIGS. 6 and 7, the all solid secondary battery 1 includes a positive electrode layer 10, a negative electrode layer 20, and a solid electrolyte layer 30 interposed between them; the positive electrode layer 10 includes a positive electrode current collector 11, a first positive electrode active material layer 12b, and a second positive electrode active material layer 12c, each disposed on both sides of the positive electrode current collector 11; the solid electrolyte layer 30 includes a first solid electrolyte layer 30b in contact with the first positive electrode active material layer 12b, and a second solid electrolyte layer 30c in contact with the second positive electrode active material layer 12c; the negative electrode layer 20 includes a first negative electrode layer 20b in contact with the first solid electrolyte layer 30b, and a second negative electrode layer 20c in contact with the second solid electrolyte layer 30c; and the inactive member 40 is disposed to surround the side of the positive electrode layer 10 between the first solid electrolyte layer 30b and the second solid electrolyte layer 30c. For example, the first inactive member 40b and the second inactive member 40c are disposed to surround the side of the positive electrode layer 10. A positive electrode uncoated part 10a extends outward from one side of the positive electrode layer 10, and a negative electrode uncoated part 20a extends outward from one side of the negative electrode layer 20.

The all solid secondary battery 1 has a bi-cell structure. Because the all solid secondary battery 1 has such bi-cell structure, the solid electrolyte layer 30 and the negative electrode layer 20 are symmetrically disposed facing each other around the positive electrode layer 10, thereby more effectively suppressing structural deformation due to pressure applied during the manufacture of the all solid secondary battery 1. Thus, cracks in the solid electrolyte layer 30 are suppressed during the manufacturing process and/or the charge-discharge cycles of the all solid secondary battery 1, thereby preventing short circuits in the all solid secondary battery 1 and ultimately improving its cycle characteristics. Moreover, since only one positive electrode current collector 11 is used for a plurality of positive electrode active material layers 12b and 12c, the energy density of the all solid secondary battery 1 is increased.

Referring to FIGS. 1 to 7, the inactive member 40 is, for example, a flame-retardant inactive member. By providing flame retardancy, the flame-retardant inactive member prevents thermal runaway and ignition in the all solid secondary battery, thereby further enhancing the safety of the all solid secondary battery. Additionally, by absorbing residual moisture within the all solid secondary battery, the flame-retardant inactive member prevents deterioration of the all solid secondary battery, thus improving its lifespan characteristics.

The flame-retardant inactive member includes a matrix and a filler. The matrix includes, for example, a substrate and a reinforcing material. The matrix includes, for example, a fibrous substrate and fibrous reinforcement. By including a substrate in the matrix, the matrix may have elasticity. Therefore, the matrix may effectively accommodate the volume changes during the charge-discharge cycles of the all solid secondary battery 1 and may be disposed in various positions. The substrate included in the matrix may include, for example, a first fibrous material. By including the first fibrous material, the substrate may effectively accommodate the volume changes of the positive electrode layer 30 during the charge-discharge cycles of the all solid secondary battery 1, and effectively suppress the deformation of the flame-retardant inactive member 40 caused by the volume changes of the positive electrode layer 30. The first fibrous material may be, for example, a material with an aspect ratio of 5 or more, 20 or more, or 50 or more. The first fibrous material is, for example, a material having an aspect ratio of 5 to 1000, 20 to 1000, or 50 to 1000. The first fibrous material is, for example, an insulating material. By being an insulating material, the first fibrous material may effectively prevent short circuits between the positive electrode layer 30 and the negative electrode layer 20 caused by lithium dendrites during the charge-discharge cycles of the all solid secondary battery 1. The first fibrous material includes, for example, one or more selected from pulp fibers, insulating polymer fibers, and ion-conducting polymer fibers. By including a reinforcing material, the matrix may have improved strength. Therefore, the matrix may prevent excessive volume changes during the charge-discharge cycles of the all solid secondary battery 1 and prevent deformation of the all solid secondary battery. The reinforcing material included in the matrix includes, for example, a second fibrous material. By including the second fibrous material, the strength of the matrix may be more uniformly increased. The second fibrous material may have, for example, an aspect ratio of 3 or more, 5 or more, or 10 or more. The first fibrous material is, for example, a material having an aspect ratio of 3 to 100, 5 to 100, or 10 to 100 The second fibrous material is, for example, a flame-retardant material. By being a flame-retardant material, the second fibrous material may effectively suppress ignition caused by thermal runaway during the charge-discharge cycles or external impact in the all solid secondary battery 1. The second fibrous material is, for example, glass fibers, metal oxide fibers, and ceramic fibers. Glass fibers are determined by the composition of metal oxides constituting the glass. Glass fibers are, for example, silicate glass fibers. Metal oxide fibers are, for example, silica (SiO₂) fibers, alumina (Al₂O₃) fibers, or bohemite fibers. Ceramic fibers are, for example, silicon carbide fibers. The flame-retardant inactive member includes a filler in addition to the matrix. The filler may be disposed inside the matrix, on the surface of the matrix, or both inside and on the surface. The filler is, for example, an inorganic material. The filler included in the flame-retardant inactive member is, for example, a moisture getter. The filler may absorb, for example, moisture at temperatures below 100° C., thereby removing residual moisture in the all solid secondary battery 1 and preventing its deterioration. Additionally, when the temperature of the all solid secondary battery 1 exceeds 150° C., due to thermal runaway during the charge-discharge cycles or external impact, the filler may release the absorbed moisture, effectively suppressing ignition of the all solid secondary battery 1. That is, the filler is, for example, a flame-retardant. The filler is, for example, a metal hydroxide having moisture adsorption properties. The metal hydroxide included in the filler is, for example, Mg(OH)₂, Fe(OH)₃, Sb(OH)₃, Sn(OH)₄, Ti(OH)₃, Zr(OH)₄, Al(OH)₃, or a combination thereof. The content of the filler included in the flame-retardant inactive member may be, for example, 10 to 80 parts by weight, 20 to 80 parts by weight, 30 to 80 parts by weight, 40 to 80 parts by weight, 50 to 80 parts by weight, 60 to 80 parts by weight, or 65 to 80 parts by weight, based on 100 parts by weight of the flame-retardant inactive member. The flame-retardant inactive member may include, for example, a binder. The binder may include, for example, a curable polymer. The curable polymer is a polymer that cures under heat and/or pressure. The curable polymer is, for example, a solid at room temperature. The flame-retardant inactive member may include, for example, a thermo-compression curable film and/or its cured product. The thermo-compression curable polymer may be, for example, TSA-66 from Toray. Alternatively, the binder may include general binders used in the relevant technical field. The binder may be, for example, a fluorine-based binder such as polyvinylidene fluoride or an acrylic binder such as polyacrylate. The content of the binder included in the flame-retardant inactive member may be, for example, 1 to 10 parts by weight, 1 to 5 parts by weight, or 1 to 3 parts by weight based on 100 parts by weight of the flame-retardant inactive member. The density of the substrate or the reinforcing material included in the flame-retardant inactive member may be, for example, 10% to 300%, 10% to 150%, 10% to 140%, 10% to 130%, or 10% to 120% of the density of the positive electrode active material included in the positive electrode active material layer 12. The flame-retardant inactive member is a member that does not include electrochemically active materials, for example, electrode active materials. Electrode active materials are materials that absorb and release lithium. The flame-retardant inactive member is made of materials other than electrode active materials, which are used in the relevant technical field.

### [Positive Electrode Layer: Positive Electrode Active Material]

The positive electrode active material layer 12 includes, for example, a positive electrode active material and a solid electrolyte. The solid electrolyte included in the positive electrode layer 10 is similar to or different from the solid electrolyte included in the solid electrolyte layer 30. For more details about the solid electrolyte, refer to the section on the solid electrolyte layer 30.

The positive electrode active material is a material that may reversibly absorb and desorb lithium ions. The positive electrode active material may be, for example, lithium transition metal oxides such as lithium cobalt oxide (LCO), lithium nickel oxide, lithium nickel cobalt oxide, lithium nickel cobalt aluminum oxide (NCA), lithium nickel cobalt manganese oxide (NCM), lithium manganese oxide, lithium iron phosphate, nickel sulfide, copper sulfide, lithium sulfide, iron oxide, or vanadium oxide, but is not limited to these examples and may include any material used as a positive electrode active material in the relevant technical field. The positive electrode active material may be used alone or as a mixture of two or more types.

The lithium transition metal oxides is, for example, a compound represented by one of the chemical formulae LiₐA_{1-b}B_{b}D₂ (where 0.90≤a≤1, and 0≤b≤0.5); LiₐE_{1-b}B_{b}O_{2-c}D_{c} (where 0.90≤a≤1, 0≤b≤0.5, 0.5≤c≤0.05); LiE_{2-b}B_{b}O_{4-c}D_{c} (where 0≤b≤0.5, 0≤c≤0.05); LiₐNi_{1-b-c}Co_{b}B_{c}D_{α} (where 0.90≤a≤1, 0≤b≤0.5, 0≤c≤0.05, 0≤α≤2); LiₐNi_{1-b-c}Co_{b}B_{c}O_{2-α}F_{α} (where 0.90≤a≤1, 0≤b≤0.5, 0≤c≤0.05, 0<α<2); LiₐNi_{1-b-c}Co_{b}B_{c}O_{2-α}F₂ (where 0.90≤a≤1, 0≤b≤0.5, 0≤c≤0.05, 0<α<2); LiₐNi_{1-b-c}Mn_{b}B_{c}D_{α} (where 0.90≤a≤1, 0≤b≤0.5, 0≤c≤0.05, 0<α≤2); LiₐNi_{1-b-c}Mn_{b}B_{c}O_{-α}F_{α} (where 0.90≤a≤1, 0≤b≤0.5, 0≤c≤0.05, 0<α<2); LiₐNi_{1-b-c}Mn_{b}B_{c}O_{2-α}F₂ (where 0.90≤a≤1, 0≤b≤0.5, 0≤c≤0.05, 0<α<2); LiₐNi_{b}E_{c}G_{d}O₂ (where 0.90≤a≤1, 0≤b≤0.9, 0≤c≤0.5, 0.001≤d≤0.1); LiₐNi_{b}Co_{c}Mn_{d}GeO₂ (where 0.90≤a≤1, 0≤b≤0.9, 0≤c≤0.5, 0≤d≤0.5, 0.001≤e≤0.1); LiₐNiG_{b}O₂ (where 0.90≤a≤1, 0.001≤b≤0.1); LiₐCoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); LiFePO₄. In these compounds, A is Ni, Co, Mn, or a combination thereof; B is Al, Ni, Co, Mn, Cr, Fe, Mg, Sr, V, a rare earth element, or a combination thereof, D is O, F, S, P, or a combination thereof; E is Co, Mn, or a combination thereof; F is F, S, P, or a combination thereof; G is A1, Cr, Mn, Fe, Mg, La, Ce, Sr, V, or a combination thereof; Q is Ti, Mo, Mn, or a combination thereof; I is Cr, V, Fe. Sc, Y, or a combination thereof; and J is V, Cr, Mn, Co, Ni, Cu, or a combination thereof. It is also possible to use compounds with a coating layer added to the surface of these compounds, as well as mixtures of the above compounds and compounds with a coating layer added. The coating layer added to the surface of these compounds includes, for example, a coating element compound such as an oxide, hydroxide, oxyhydroxide, oxycarbonate, or hydroxycarbonate of the coating element. The compounds that make up this coating layer are amorphous or crystalline. The coating elements included in the coating layer include Mg, A1, Co, K, Na, Ca, Si, Ti, V, Sn, Ge, Ga, B, As, Zr, or a mixture thereof. The method of forming the coating layer is selected within a range that does not adversely affect the physical properties of the positive electrode active material. The coating method is, for example, spray coating, dipping method, etc. The specific coating methods are well understood by those skilled in the art, so detailed descriptions are omitted.

The positive electrode active material includes, for example, lithium salts of the transition metal oxides with a layered rock salt type structure among the lithium transition metal oxides mentioned above. A “layered rock salt type structure” refers to a structure in which oxygen atom layers and metal atom layers are alternately and regularly arranged in the <111> direction of a cubic rock salt type structure, thereby forming each atomic layer into a two-dimensional plane. A “cubic rock salt type structure” refers to a type of crystal structure known as a sodium chloride (NaCl) type structure, specifically, it describes a structure where the face-centered cubic lattices (fcc) formed by cations and anions are offset from each other by half the length of the unit lattice's ridge. Lithium transition metal oxides with this layered rock salt structure are, for example, ternary lithium transition metal oxides such as LiNiₓCo_{y}Al_{z}O₂ (NCA) or LiNiₓCo_{y}Mn₂O₂ (NCM) (0<x<1, 0<y<1, 0<z<1, x+y+z=1). When the positive electrode active material includes ternary lithium transition metal oxides with a layered rock salt type structure, the energy density and thermal stability of the all solid secondary battery 1 are further enhanced. The positive electrode active material may be covered with a coating layer as described above. The coating layer may be any coating layer known as a coating layer for the positive electrode active material of the all solid secondary battery. The coating layer is, for example, Li₂O—ZrO₂ (LZO).

When the positive electrode active material includes, for example, nickel (Ni) as a ternary lithium transition metal oxide such as NCA or NCM, the capacity density of the all solid secondary battery 1 may increase, reducing metal elution from the positive electrode active material in the charged state. As a result, the cycle characteristics of the all solid secondary battery 1 in the charged state is improved.

The shape of the positive electrode active material is, for example, a particle shape of a sphere, an elliptical sphere, or the like. The particle size of the positive electrode active material is not particularly limited and is within the range applicable to the positive electrode active material of conventional all solid secondary batteries. The content of the positive electrode active material in the positive electrode layer 10 is also not particularly limited, and is within a range applicable to the positive electrode layer of a conventional all solid secondary battery.

### [Positive Electrode Layer: Solid Electrolyte]

The positive electrode active material layer 12 may include, for example, a solid electrolyte. The solid electrolyte included in the positive electrode layer 10 may be the same as or different from the solid electrolyte included in the solid electrolyte layer 30. For detailed information about the solid electrolyte, refer to the section on the solid electrolyte layer 30.

The solid electrolyte included in the positive electrode active material layer 12 may have a smaller D50 average particle size compared to the solid electrolyte included in the solid electrolyte layer 30. For example, the D50 average particle size of the solid electrolyte in the positive electrode active material layer 12 may be 90% or less, 80% or less, 70% or less, 60% or less, 50% or less, 40% or less, 30% or less, or 20% or less of the D50 average particle size of the solid electrolyte in the solid electrolyte layer 30.

The D50 average particle diameter refers to, for example, the median particle diameter (D50). The median particle diameter (D50) is the particle size corresponding to 50% cumulative volume calculated from the smaller particle size side in the particle size distribution measured by, for example, laser diffraction.

### [Positive Electrode Layer: Binder]

The positive electrode active material layer 12 may include a binder. The binder is, for example, styrene butadiene rubber (SBR), polytetrafluoroethylene, polyvinylidene fluoride, polyethylene, or the like, but is not limited to these and may include any material used as a binder in the relevant technical field.

### [Positive Electrode Layer: Conductive Material]

The positive electrode active material layer 12 may include a conductive material. The conductive material is, for example, graphite, carbon black, acetylene black, Ketjen black, carbon fiber, metal powder, etc., but is not limited to these and may include any material used as a conductive material in the relevant technical field.

### [Positive Electrode Layer: Other Additives]

In addition to the aforementioned positive electrode active material, solid electrolyte, binder, and conductive material, the positive electrode active material layer 12 may include, for example, additives such as fillers, coating agents, dispersants, and ionic conductivity auxiliary agent.

The fillers, coating agents, dispersants, and ionic conductivity enhancers that may be included in the positive electrode active material layer 12 are generally known materials used in the electrodes of all solid secondary batteries.

### [Positive Electrode Layer: Positive Electrode Current Collector]

The positive electrode current collector 11 include, for example, plates or foils made of indium (in), copper (Cu), magnesium (Mg), stainless steel, titanium (Ti), iron (Fe), cobalt (Co), nickel (Ni), zinc (Zn), aluminum (A1), germanium (Ge), lithium (Li), or alloys thereof. The positive electrode current collector 11 may be omitted. The thickness of the positive electrode current collector 11 is, for example, 1 μm to 100 μm, 1 μm to 50 μm, 5 μm to 25 μm, or 10 μm to 20 μm.

### [Solid Electrolyte Layer]

### [Solid Electrolyte Layer: Solid Electrolyte]

Referring to FIGS. 1 to 4, the solid electrolyte layer 30 includes a solid electrolyte interposed between the positive electrode layer 10 and the negative electrode layer 20.

The solid electrolyte is, for example, a sulfide-based solid electrolyte. The sulfide-based solid electrolyte is, for example, one or more selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—Li, Li₂S—SiS₂—P₂S₅—Li, Li₂S—B₂S₃, Li₂S—P₂S₅—ZmSn (where m and n are positive numbers, and Z is one of Ge, Zn, or Ga), Li₂S—GeS₂, Li₂S—SiS₂—Li₃PO₄, Li₂S—SiS₂—LiₚMO_{q} (where p and q are positive numbers, and M is one of P. Si, Ge, B, A1, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). The sulfide-based solid electrolyte may be manufactured, for example, by processes such as melt quenching or mechanical milling of starting materials like Li₂S and P₂S₅. Additionally, heat treatment may be performed after these processes. The solid electrolyte may be amorphous, crystalline, or a mixture of both. Additionally, the solid electrolyte may include, for example, at least sulfur (S), phosphorus (P), and lithium (Li) as constituent elements among the sulfide-based solid electrolyte materials described above. For example, the solid electrolyte may be a material containing Li₂S—P₂S₅. When using material containing Li₂S—P₂S₅ as the sulfide-based solid electrolyte material to form a solid electrolyte, the mixing molar ratio of Li₂S to P₂S₅ is, for example, in the range of Li₂S:P₂S₅=50:50 to 90:10.

The sulfide-based solid electrolyte may include, for example, an argyrodite-type solid electrolyte represented by the following Formula (1):

Li⁺₁₂₋ₙ₋ₓAⁿ⁺X²⁻₆₋ₓY⁻ₓ <Formula 1>
in the Formula, A is P, As, Ge, Ga, Sb, Si, Sn, A1, In, Ti, V, Nb or Ta, X is S, Se or Te, and Y is Cl, Br, I, F, CN, OCN, SCN, or N₃, where 1≤n≤5 and 0≤x≤2. The sulfide-based solid electrolyte may be, for example, an argyrodite-type compound containing one or more selected from Li₇₋ₓPS₆₋ₓClₓ, 0≤x≤2, Li₇₋ₓPS₆₋ₓBrₓ, 0≤x≤2, and Li₇₋ₓPS₆₋ₓIₓ, where 0≤x≤2. The sulfide-based solid electrolyte may be, for example, an argyrodite-type compound containing one or more selected from Li₆PS₅Cl, Li₆PS₅Br, and Li₆PS₅I.

The density of the argyrodite-type solid electrolyte may be 1.5 to 2.0 g/cc. By having a density of 1.5 g/cc or more, the argyrodite-type solid electrolyte may reduce the internal resistance of the all solid secondary battery and effectively suppress the penetration of the solid electrolyte layer by Li.

### [Solid Electrolyte Layer: Binder]

The solid electrolyte layer 30 may include, for example, a binder. The binder included in the solid electrolyte layer 30 is, for example, styrene butadiene rubber (SBR), polytetrafluoroethylene, polyvinylidene fluoride, polyethylene, etc., but is limited to these and includes any binder used in the relevant technical field. The binder of the solid electrolyte layer 30 may be the same as or different from the binder included in the positive electrode active material layer 12 and the negative electrode active material layer 22. The binder may be omitted.

The content of the binder included in the solid electrolyte layer 30 is 0 wt % to 10 wt %, 0 wt % to 5 wt %, 0 wt % to 3 wt %, 0 wt % to 1 wt %, 0 wt % to 0.5 wt %, or 0 wt % to 0.1 wt % based on the total weight of the solid electrolyte layer 30.

### [Negative Electrode Layer]

### [Negative Electrode Layer: Negative Electrode Active Material]

The first negative electrode active material layer 22 includes, for example, a negative electrode active material and a binder.

The negative electrode active material included in the first negative electrode active material layer 22 is, for example, in particulate form. The average particle size of the negative electrode active material in particulate form is, for example, 4 μm or less, 3 μm or less, 2 μm or less, 1 μm or less, or 900 nm or less. The average particle size of the negative electrode active material in particulate form may be 10 nm to 4 μm or less, 10 nm to 3 μm or less, 10 nm to 2 μm or less, 10 nm to 1 μm or less, or 10 nm to 900 nm or less. As the negative electrode active material has an average particle size in this range, reversible absorption and/or desorbing of lithium may be more facilitated during charging and discharging. The average particle size of the negative electrode active material may be the median diameter (D50) measured using, for example, a laser particle size distribution analyzer.

The negative electrode active material included in the first negative electrode active material layer 22 includes, for example, one or more selected from carbon-based negative electrode active materials and metal or metalloid negative electrode active materials.

The carbon-based negative electrode active material is particularly amorphous carbon. Amorphous carbon is, for example, carbon black (CB), acetylene black (AB), furnace black (FB), ketjen black (KB), and graphene, etc., but is not necessarily limited to these, and may include any material classified as amorphous carbon in the relevant technical field. Amorphous carbon is carbon that lacks crystallinity or has very low crystallinity, distinguishing it from crystalline carbon or graphite-based carbon.

The metal or metalloid negative electrode active materials include one or more selected from the group consisting of gold (Au), platinum (Pt), palladium (Pd), silicon (Si), silver (Ag), aluminum (A1), bismuth (Bi), tin (Sn), and zinc (Zn), but is not limited to these and may include any material used as a metal or metalloid negative electrode active material that forms an alloy or compound with lithium in the relevant technical field. For example, nickel (Ni) does not form an alloy with lithium, so it is not a metal negative electrode active material.

The first negative electrode active material layer 22 may include a single type of negative electrode active material or a mixture of different negative electrode active materials. For example, the first negative electrode active material layer 22 includes only amorphous carbon, or one or more selected from the group consisting of gold (Au), platinum (Pt), palladium (Pd), silicon (Si), silver (Ag), aluminum (A1), bismuth (Bi), tin (Sn), and zinc (Zn). Alternatively, the first negative electrode active material layer 22 includes a mixture of amorphous carbon and one or more selected from the group consisting of gold (Au), platinum (Pt), palladium (Pd), silicon (Si), silver (Ag), aluminum (A1), bismuth (Bi), tin (Sn), and zinc (Zn). The mixing ratio of the mixture of amorphous carbon and metals such as gold is, for example, 10:1 to 1:2, 5:1 to 1:1, or 4:1 to 2:1 by weight ratio, but this ratio is not limited to these ranges and may be selected based on the required characteristics of the all solid secondary battery 1. By having the negative electrode active material with such composition, the cycle characteristics of the all solid secondary battery 1 may be further improved.

The negative electrode active material included in the first negative electrode active material layer 22 includes: for example, a mixture of first particles made of amorphous carbon and second particles made of metal or metalloid. The metals or metalloids include, for example, gold (Au), platinum (Pt), palladium (Pd), silicon (Si), silver (Ag), aluminum (A1), bismuth (Bi), tin (Sn), and zinc (Zn). Metalloids are alternatively semiconductors. The content of the second particles may be 8% by weight to 60% by weight, 10% by weight to 50% by weight, 15% by weight to 40% by weight, or 20% by weight to 30% by weight, based on the total weight of the mixture. Having the second particles within this range of content may further improve the cycle characteristics of the all solid secondary battery 1.

### [Negative Electrode Layer: Binder]

The binder included in the first negative electrode active material layer 22 is, for example, styrene-butadiene rubber (SBR), polytetrafluoroethylene, polyvinylidene fluoride, polyethylene, vinylidene fluoride/hexafluoropropylene copolymer, polyacrylonitrile, polymethyl methacrylate, etc., but is not limited to these and may include any material used as a binder in the relevant technical field. The binder may be composed of a single binder or multiple different binders.

Including a binder in the first negative electrode active material layer 22 stabilizes the first negative electrode active material layer 22 on the negative electrode current collector 21. In addition, cracking of the first negative electrode active material layer 22 is suppressed despite volume changes and/or relative positional change of the first negative electrode active material layer 22 during the charge-discharge cycles. For example, when the first negative electrode active material layer 22 does not include a binder, it is possible for the first negative electrode active material layer 22 to be easily separated from the negative electrode current collector 21. The detachment of the first negative electrode active material layer 22 from the negative electrode current collector 21 increases the likelihood of short circuits because the exposed portions of the negative electrode current collector 21 come into contact with the solid electrolyte layer 30. The first negative electrode active material layer 22 is manufactured, for example, by applying a slurry in which the material constituting the first negative electrode active material layer 22 is dispersed onto the negative electrode current collector 21 and then drying it. By including a binder in the first negative electrode active material layer 22, stable dispersion of the negative electrode active material in the slurry is possible. For example, when applying the slurry on the negative electrode current collector 21 using a screen printing method, it is possible to prevent clogging of the screen (e.g., clogging due to agglomerates of the negative electrode active material).

### [Negative Electrode Layer: Other Additives]

The first negative electrode active material layer 22 may include additional additives commonly used in conventional all solid secondary batteries 1, such as fillers, coating agents, dispersants, and ionic conductive auxiliaries.

### [Negative Electrode Layer: First Negative Electrode Active Material Layer]

The thickness of the first negative electrode active material layer 22 may be, for example, 50% or less, 40% or less, 30% or less, 20% or less, 10% or less, or 5% or less of the thickness of the positive electrode active material layer 12. The thickness of the first negative electrode active material layer 22 may be, for example, 1 μm to 20 μm, 2 μm to 10 μm, or 3 μm to 7 μm. If the thickness of the first negative electrode active material layer 22 is too thin, lithium dendrites formed between the first negative electrode active material layer 22 and the negative electrode current collector 21 may cause the first negative electrode active material layer 22 to collapse, making it difficult to improve the cycle characteristics of the all solid secondary battery 1. If the thickness of the first negative electrode active material layer 22 is too thick, the energy density of the all solid secondary battery 1 may decrease, and the internal resistance caused by the first negative electrode active material layer 22 may increase, making it difficult to improve the cycle characteristics of the all solid secondary battery 1.

As the thickness of the first negative electrode active material layer 22 decreases, the charge capacity of the first negative electrode active material layer 22 also decreases. For example, the charge capacity of the first negative electrode active material layer 22 is, for example, 50% or less, 40% or less, 30% or less, 20% or less, 10% or less, 5% or less, or 2% or less of the charge capacity of the positive electrode active material layer 12. The charge capacity of the first negative electrode active material layer 22 is, for example, between 0.1% and 50%, 0.1% and 40%, 0.1% and 30%, 0.1% and 20%, 0.1% and 10%, 0.1% and 5%, or 0.1% and 2% of the charging capacity of the positive electrode active material layer (12). If the charge capacity of the first negative electrode active material layer 22 is too small, the first negative electrode active material layer 22 becomes very thin, and lithium dendrites formed between the first negative electrode active material layer 22 and the negative electrode current collector 21 during repeated charge-discharge cycles cause the first negative electrode active material layer 22 to collapse, making it difficult to improve the cycle characteristics of the all solid secondary battery 1. If the charge capacity of the first negative electrode active material layer 22 is too large, the energy density of the all solid secondary battery 1 decreases, and the internal resistance caused by the first negative electrode active material layer 22 increases, making it difficult to improve the cycle characteristics of the all solid secondary battery 1.

The charge capacity of the positive electrode active material layer 12 is obtained by multiplying the charge capacity density (mAh/g) of the positive electrode active material by the mass of the positive electrode active material in the positive electrode active material layer 12. When multiple types of positive electrode active materials are used, the charge capacity density×mass value is calculated for each positive electrode active material, and the sum of these values is the charge capacity of the positive electrode active material layer 12. The charging capacity of the first negative electrode active material layer 22 is also calculated in the same way. That is, the charge capacity of the first negative electrode active material layer 22 is obtained by multiplying the charge capacity density (mAh/g) of the negative electrode active material by the mass of the negative electrode active material in the first negative electrode active material layer 22. When multiple types of negative electrode active materials are used, the charge capacity density×mass value is calculated for each negative electrode active material, and the sum of these values is the capacity of the first negative electrode active material layer 22. Here, the charge capacity density of the positive electrode active material and the negative electrode active material is the capacity estimated using an all solid half-cell using lithium metal as a counter electrode. The charge capacities of the positive electrode active material layer 12 and the first negative electrode active material layer 22 are directly measured by measuring the charge capacity using an all solid half-cell. By dividing the measured charging capacity by the mass of each active material, the charging capacity density is obtained. Alternatively, the charge capacity of the positive electrode active material layer 12 and the first negative material layer 22 may be the initial electrode active charge capacity measured during the first charging cycle.

### [Negative Electrode Layer: Second Negative Electrode Active Material Layer]

Although not shown in the drawings, the all solid secondary battery 1 may further include, for example, a second negative electrode active material layer disposed between the negative electrode current collector 21 and the first negative electrode active material layer 22 during charging. The second negative electrode active material layer is a metal layer containing lithium or a lithium alloy. The metal layer includes lithium or a lithium alloy. Therefore, the second negative electrode active material layer, being a metal layer containing lithium, it functions as a lithium reservoir. Lithium alloys are, for example, Li—A1 alloy, Li—Sn alloy, Li—In alloy, Li—Ag alloy, Li—Au alloy, Li—Zn alloy, Li—Ge alloy, Li—Si alloy, etc., but they are not limited thereto, and may include any lithium alloy used in the relevant technical field. The second negative electrode active material layer may be composed of one of these alloys or lithium, or may be composed of several types of alloys. The second negative electrode active material layer is, for example, a plated layer. For example, the second negative electrode active material layer may be precipitated between the first negative electrode active material layer 22 and the negative electrode current collector 21 during the charging process of the all solid secondary battery 1.

The thickness of the second negative electrode active material layer is not particularly limited, but may be, for example, from 1 μm to 1000 μm, 1 μm to 500 μm, 1 μm to 200 μm, 1 μm to 150 μm, 1 μm to 100 μm, or 1 μm to 50 μm. If the thickness of the second negative electrode active material layer is too thin, it is difficult for the second negative electrode active material layer to function as a lithium reservoir. If the thickness of the second negative active material layer is too thick, the mass and volume of the all solid secondary battery 1 may increase and cycle characteristics may deteriorate. The second negative electrode active material layer may be, for example, a metal foil with thickness within these ranges.

In the all solid secondary battery 1, the second negative electrode active material layer may be disposed between the negative electrode current collector 21 and the first negative electrode active material layer 22 before the assembly of the all solid secondary battery 1, or it may be precipitated between the negative electrode current collector 21 and the first negative electrode active material layer 22 during charging after the assembly of the all solid secondary battery 1. When the second negative electrode active material layer 23 is disposed between the negative electrode current collector 21 and the first negative electrode active material layer 22 before the assembly of the all solid secondary battery 1, it acts as a lithium reservoir since it is a metal layer containing lithium. For example, a lithium foil is disposed between the negative electrode current collector 21 and the first negative electrode active material layer 22 before assembling the all solid secondary battery 1. As a result, the cycle characteristics of the all solid secondary battery 1 including the second negative electrode active material layer are further improved. When the second negative electrode active material layer is precipitated during charging after the assembly of the all solid secondary battery 1, the energy density of the all solid secondary battery 1 is increased because the second negative electrode active material layer is not included during assembly of the all solid secondary battery 1. For example, during the charging of the all solid secondary battery 1, the first negative electrode active material layer 22 is charged beyond its capacity. That is, the first negative electrode active material layer 22 is overcharged. At the beginning of charging, lithium is absorbed into the first negative electrode active material layer 22. The negative electrode active material included in the first negative electrode active material layer 22 forms an alloy or compound with lithium ions moving from the positive electrode layer 10. If the first negative electrode active material layer 22 is overcharged beyond its capacity, lithium is precipitated, for example, on the rear surface of the first negative electrode active material layer 22, i.e., between the negative electrode current collector 21 and the first negative electrode active material layer 22, forming a metal layer corresponding to the second negative electrode active material layer. The second negative electrode active material layer is a metal layer mainly composed of lithium (i.e. metallic lithium). This result is obtained, for example, by composing the negative electrode active material included in the first negative electrode active material layer 22 with materials that form alloys or compounds with lithium. During discharge, lithium in the first negative electrode active material layer 22 and the second negative electrode active material layer, that is, the metal layer, is ionized and moves toward the positive electrode layer 10. Therefore, lithium may be used as the negative electrode active material in the all solid secondary battery 1. Additionally, since the first negative electrode active material layer 22 covers the second negative electrode active material layer, it acts as a protective layer for the second negative electrode active material layer (i.e., the metal layer) while simultaneously suppressing the precipitation growth of lithium dendrites. Thus, it prevents short circuits and capacity degradation in the all solid secondary battery 1, consequently improving its cycle characteristics. In addition, when the second negative electrode active material layer is disposed by charging after assembly of the all solid secondary battery 1, the negative electrode current collector 21 and the first negative electrode active material layer 22 and the area between them are, for example, a Li-free region that does not contain lithium (Li) in the initial or post-discharge state of a solid secondary battery.

### [Negative Electrode Layer: Negative Electrode Current Collector]

The negative electrode current collector 21 is composed of a material that does not react with lithium, that is, does not form any alloy or compound. The materials constituting the negative electrode current collector 21 include, for example, copper (Cu), nickel-coated copper (Ni-coated Cu), stainless steel (SUS), titanium (Ti), iron (Fe), cobalt (Co), and nickel (Ni), but the materials are not limited to these and may include any materials used as current collectors in the relevant technical field. The negative electrode current collector 21 may be composed of one of the above-described metals, an alloy of two or more metals, or a coating material. The negative electrode current collector 21 is, for example, plate-shaped or foil-shaped.

The all solid secondary battery 1 may further include, for example, a thin film containing an element capable of forming an alloy with lithium on the negative electrode current collector 21. The thin film is disposed between the negative electrode current collector 21 and the first negative electrode active material layer 22. The thin film includes elements that can form alloys, for example with lithium. Elements that can form an alloy with lithium include, for example, gold, silver, zinc, tin, indium, silicon, aluminum, and bismuth, but are not necessarily limited to these, and may include any elements that can form an alloy with lithium in the relevant technical art. The thin film is composed of one of these metals or an alloy of several types of metals. By disposing the thin film on the negative electrode current collector 21, the precipitated form of the second negative electrode active material layer, which precipitates between the thin film 24 and the first negative electrode active material layer 22, becomes more uniform, thereby improving the cycle characteristics of the all solid secondary battery 1.

The thickness of the thin film is, for example, 1 nm to 800 nm, 10 nm to 700 nm, 50 nm to 600 nm, or 100 nm to 500 nm. If the thickness is less than 1 nm, the thin film may not perform its intended function. If the thickness is too great, the thin film itself may absorb lithium, reducing the lithium precipitation amount in the negative electrode, thereby decreasing the energy density and cycle characteristics of the all solid secondary battery 1. The thin film may be disposed on the negative electrode current collector 21 by, for example, vacuum deposition, sputtering, plating, etc., but it is not necessarily limited to these methods and any method that can form a thin film in the art is possible.

### [All Solid Secondary Battery Structure]

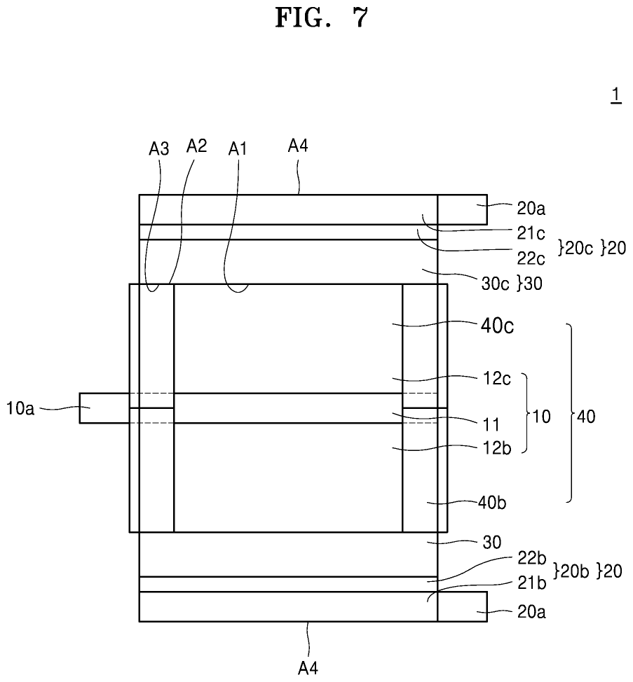

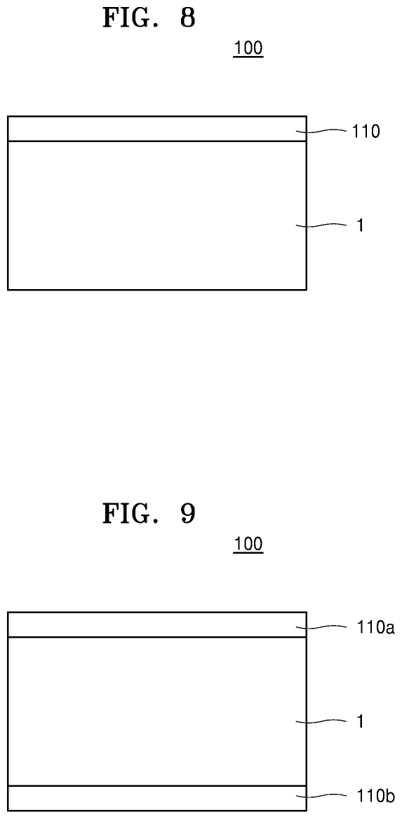

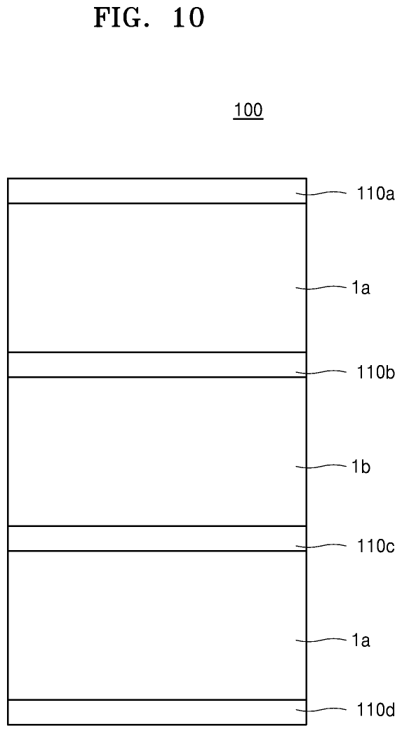

FIG. 8 is a cross-sectional view of a mono-cell all solid secondary battery structure according to an exemplary embodiment. FIG. 9 is a cross-sectional view of a bi-cell all solid secondary battery structure according to an exemplary embodiment. FIG. 10 is a cross-sectional view of an all solid secondary battery structure according to an exemplary embodiment.

An all solid secondary battery structure 100 according to another embodiment includes one or more all solid secondary batteries 1 described above, and a buffering member 110 disposed on at least one side or both surfaces of the all solid secondary battery 1. The buffering member may be, for example, porous polymer foam, porous polymer sponge, rubber, etc., but is not necessarily limited to these, and any material having elasticity and resilience that is used in the art may be used. The elastic modulus of the buffer member is lower than that of the solid electrolyte layer. The elastic modulus of the cushioning member may be, for example, 0.001 GPa to 0.5 GPa, 0.01 GPa to 0.3 GPa, or 0.01 GPa to 0.1 GPa.

By disposing a buffering member on one or both surfaces of a single all solid secondary battery or a stack of multiple all solid secondary batteries, the volume changes during charging and discharging may be effectively accommodated, thereby improving the safety of the all solid secondary battery structure. Consequently, the lifespan characteristics of the all solid secondary battery are enhanced.

Referring to FIG. 8, the all solid secondary battery structure 100 includes an all solid secondary battery 1, and a buffering member 110 disposed on one surface of the all solid secondary battery 1.

Referring to FIG. 9, the all solid secondary battery structure 100 includes an all solid secondary battery 1, and buffering members 110a and 110b disposed on both surfaces of the all solid secondary battery 1.

Referring to FIG. 10, the all solid secondary battery structure 100 includes a plurality of all solid secondary batteries 1a, 1b, and 1c stacked along one direction, and buffering members 110a. 110b, 110c, 110d disposed between the plurality of all solid secondary batteries 1a, 1b, 1c and on the uppermost and lowermost surfaces of the stacked all solid secondary batteries 1a, 1b, 1c.

Although not shown in the drawing, pressure plates may be additionally disposed on both sides of the all solid secondary battery stack in the all solid secondary battery structure 100. By additionally placing a pressure plate, a constant pressure may be applied to the all solid secondary battery stack.

### [Manufacturing of All Solid Secondary Battery]

### (Manufacturing of the Negative Electrode Layer)

The negative electrode layer may be manufactured by, for example, the following method. A negative electrode slurry is prepared by mixing the negative electrode active material, conductive material, binder, and solvent. A negative electrode layer is prepared by coating the negative electrode slurry on the negative electrode current collector and drying it. The solvent used in the production of the negative electrode slurry is not particularly limited, and any solvent used in the negative electrode slurry in the art is possible. The solvent used in the negative electrode slurry is, for example, NMP. For the type and content of the negative electrode current collector, negative electrode active material, conductive material, and binder, refer to the negative electrode layer section described above.

Specifically, the negative electrode slurry is coated along the machine direction (MD) on the center of the negative electrode current collector supplied in a reel form. The area adjacent to both ends of the negative electrode current collector is not coated with negative electrode slurry and is kept as an uncoated part. The negative electrode slurry coated on the negative electrode current collector is dried and then roll pressed to produce a negative electrode layer.

### (Manufacturing of the Solid Electrolyte Layer)

The solid electrolyte layer may be manufactured by coating a solid electrolyte slurry and then drying it.

The solid electrolyte slurry may be prepared, for example, as follows. The solid electrolyte slurry is prepared by mixing the sulfide-based solid electrolyte, binder, and solvent. For the sulfide-based solid electrolyte and binder, refer to the solid electrolyte layer section described above. The binder may be the same or different from the binder used in the dry method. The binder used in the solid electrolyte layer is, for example, styrene butadiene rubber (SBR), polytetrafluoroethylene, polyvinylidene fluoride, polyethylene, etc., but is not limited to these, and may include any material used as a binder in the relevant technical field. The solvent is not particularly limited, and any solvent that does not react with the sulfide-based solid electrolyte and is able to dissolve the binder is possible. The solvent may be, for example, octyl acetate. For the type and content of solid electrolyte and binder, refer to the solid electrolyte layer section described above.

### (Manufacturing of the Positive Electrode Layer)

The positive electrode layer may be manufactured by, for example, the following method. The positive electrode active material, sulfide-based solid electrolyte, conductive material, binder, and solvent are mixed to prepare a positive electrode slurry. The positive electrode slurry is coated onto one or both surfaces of the positive electrode current collector, and then dried to prepare a positive electrode layer. The solvent used in the production of the positive electrode slurry is not particularly limited, and any solvent used in the positive electrode slurry in the art is possible. The solvent used in the positive electrode slurry is, for example, para-xylene. For the type and content of the positive electrode current collector, positive electrode active material, conductive material, and binder, refer to the positive electrode layer section described above. A part of the positive electrode current collector is maintained as an uncoated part, and is cut to a certain size by notching according to the required battery specifications.

### (Manufacturing of the All Solid Secondary Battery)

First, a solid electrolyte slurry is coated along the machine direction (MD) on the first negative electrode active material layer of the negative electrode layer, followed by hot air drying and vacuum drying to prepare a first assembly with the solid electrolyte layer disposed on the negative electrode layer.

The solid electrolyte layer is disposed on the first negative electrode active material layer, and uncoated parts are disposed at both ends of the first assembly. The temperature conditions and duration for hot air drying and vacuum drying may be selected based on the required battery specifications.

The center of the first assembly may be cut along the machine direction to prepare a first assembly with uncoated areas at only one end.

Subsequently, a second assembly is prepared by aligning an inactive member reel in which a plurality of inactive members including position determination parts are connected on the solid electrolyte layer of the first assembly.

One end of the inactive member reel in which a plurality of inactive members are connected is aligned along the boundary of the coated part and uncoated part. The inactive member reel may be, for example, aligned along the machine direction (MD) on the first assembly. The inactive member reel which is aligned on the first assembly is pressed and laminated to prepare the second assembly. The conditions for pressing and lamination may be selected based on the required battery specifications.

Subsequently, referring to the position determination parts of the inactive member reel, the uncoated part included in the negative electrode layer is cut to prepare a third assembly.

Among the uncoated parts included in the second assembly, the remaining uncoated parts excluding the uncoated part connected to the tab or external terminal are selectively removed. The selective removal of uncoated parts may be performed by pressing or laser notching. Among the uncoated parts included in the second assembly, the position of the uncoated part connected to the tab or external terminal may be determined by the position determination part included in the inactive member reel. For example, the remaining uncoated part may be cut and removed, leaving only the uncoated part in a certain area around the position determination part included in the inactive member reel.

Subsequently, referring to the position determination parts of the inactive members, the third assembly is cut to prepare a fourth assembly, which includes one inactive member.

The third assembly, stacked with a reel of multiple inactive members, is cut according to the cutting positions determined by the position determination parts. The fourth assembly is a laminate of the negative electrode layer/solid electrolyte layer/inactive member.

Subsequently, the fourth assembly is disposed on one or both surfaces of the positive electrode layer so that the inactive member surrounds the side of the positive electrode layer, thereby manufacturing the all solid secondary battery.

The fourth assembly is disposed on one or both surfaces of the positive electrode layer and pressurized to manufacture a mono-cell all solid secondary battery. When the fourth assemblies on both sides of the positive electrode layer are respectively disposed and pressurized, a bi-cell all solid secondary battery is manufactured.

A buffering member is disposed on one or both surfaces of the manufactured all solid secondary battery, and is vacuum sealed with an exterior material to complete an all solid secondary battery.

Additionally, the method may further include introducing a position determination part into the reel of inactive members prior to aligning the inactive member reel to the first assembly.

The position determination part may be introduced on the outer surface of the inactive member. The method of introducing the position determination part into the inactive member is, but is not limited to, press or laser notching. For example, a position determination part may be introduced by cutting the inactive member into a certain shape and removing it at a position required to align the reel of the inactive members. The size and/or shape of the position determination part is not particularly limited, and any size and/or shape that facilitates aligning the inactive member reel on the first assembly is possible. The shape of the position determination part may be, for example, a polygon such as a triangle or square. The position determination part may be introduced in a form that indents from the outer side towards the inner side of the inactive member.

### Mode for Invention

The following examples and comparative examples illustrate the present inventive concept in more detail. However, these examples are provided for illustrative purposes only and are not intended to limit the scope of the present inventive concept.

### Example 1: Mono-Cell All Solid Secondary Battery

### (Manufacturing of the Negative Electrode Layer)

A SUS sheet with a thickness of 10 μm was prepared as the negative electrode current collector. Carbon black (CB) with a primary particle size of approximately 30 nm and silver (Ag) particles with an average particle diameter of about 60 nm were prepared as negative electrode active materials.

4 g of a mixed powder of carbon black and silver particles in a weight ratio of 3:1 was placed in a container, and 4 g of an NMP solution containing 7 wt % PVDF binder (Kureha #9300) was added to prepare a mixed solution. NMP was gradually added to the prepared mixed solution while stirring to prepare a slurry. The slurry was coated on the SUS sheet using a bar coater and dried at 80° C., for 10 minutes in the air to prepare a laminate. The obtained laminate was vacuum-dried at 40° C., for 10 hours. The dried laminate was cold roll-pressed at a pressure of 5 tonf/cm² to flatten the surface of the first negative electrode active material layer. The negative electrode layer was thus fabricated. The thickness of the first negative electrode active material layer included in the negative electrode layer was about 7 μm. The area of the first negative electrode active material layer was smaller than the area of the negative electrode current collector. A part of the negative electrode current collector was an uncoated area without the first negative electrode active material layer, referred to as the negative electrode layer uncoated part.

### (Manufacturing of the Positive Electrode Layer)

Li₂O—ZrO₂ (LZO) coated LiNi_{0.8}Co_{0.15}Mn_{0.05}O₂ (NCM) was prepared as the positive electrode active material. The LZO-coated positive electrode active material was prepared according to the method disclosed in Korean Patent Publication No. 10-2016-0064942. Li₆PS₅Cl (D50=0.5 μm, crystalline), an argyrodite type crystal, was prepared as a solid electrolyte. Poly(tetrafluoroethylene) (PTFE) binder (Teflon binder from DuPont) was prepared as the binder. Carbon nanofiber (CNF) was prepared as the conductive agent. These materials were mixed in a weight ratio of 84:11.5:3:1.5 with xylene solvent to form a sheet, and the sheet was vacuum-dried at 40° C., for 8 hours to prepare the positive electrode sheet. The positive electrode sheet was placed on one side of the aluminum foil current collector, which had a carbon coating on one side, and heated roll-pressed at a pressure of 5 tonf/cm² at 85° C., to manufacture the positive electrode layer. The thickness of the positive electrode layer was about 120 μm. The thickness of the positive electrode active material layer was about 96 μm, and the thickness of the carbon-coated aluminum foil was about 24 μm. The area of the positive electrode active material layer was smaller than the area of the positive electrode current collector. A part of the positive electrode current collector was an uncoated area without the positive electrode active material layer, referred to as the positive electrode uncoated part

### (Manufacturing of the Solid Electrolyte Layer)

A mixture was prepared by adding 1.5 parts by weight of an acrylic binder to 98.5 parts by weight of a crystalline argyrodite-type Li₆PS₅Cl solid electrolyte (D50=3.0 μm, crystalline). The prepared mixture was stirred while adding octyl acetate to form a slurry. The slurry was then coated onto a 15 μm thick non-woven fabric placed on a 75 μm thick PET substrate using a bar coater and dried at 80° C., for 10 minutes in air to obtain a laminate. The obtained laminate was vacuum dried at 80° C., for 2 hours. A solid electrolyte layer was manufactured through the above process.

### (Manufacturing of the Flame-Retardant Inactive Member)

A slurry prepared by mixing cellulose fiber, glass fiber, aluminum hydroxide (Al(OH)₃), acrylic binder, and solvent was molded into a specific shape, and the solvent was removed to manufacture the flame-retardant inactive member.

The weight ratio of cellulose fiber, glass fiber, aluminum hydroxide (Al(OH)₃), and acrylic binder was 20:8:70:2. The manufactured flame-retardant member was left at room temperature for one week before use.

The inactive member was prepared in the form of a reel in which a plurality of inactive members are connected. Each flame-retardant inactive member was prepared in the shape of a gasket.

The position determination part 1-1 was disposed on the first side of the inactive member, and the position determination part 1-2 was disposed at a symmetrical position on the second side opposite the first side. On both sides of the position determination part 1-1, position determination parts 2-1 and 2-2 were disposed to determine the width of an inactive member, and position determination parts 2-3 and 2-4 were respectively disposed at symmetrical positions on the second side opposing the first side. A position determination part 3-1 was disposed between the position determination parts 1-1 and 2-1, a position determination part 3-2 was disposed between the position determination parts 1-1 and 2-2, a position determination part 3-3 was disposed between the position determination parts 1-2 and 2-3, and a position determination part 3-4 was disposed between the position determination parts 1-2 and 2-4.

The position determination parts from 1-1 to 3-4 were all introduced as recessed parts extending inward from the side of the inactive member in an equilateral triangle shape, with the same size for each recessed part.

### (Manufacture of all Solid Secondary Batteries)

Referring to FIG. 1, a first assembly was prepared by disposing a solid electrolyte layer on the coated part of the negative electrode layer so that the first negative electrode active material layer was in contact with the solid electrolyte layer.

A second assembly was prepared by disposing an inactive member reel in which a plurality of inactive members were connected on the solid electrolyte layer of the first assembly. The position determination parts 1-1, 2-1, 2-2, 3-1, and 3-2 on the first side of the inactive members were aligned along the boundary of the coated part and the uncoated part of the negative electrode layer.

With reference to the position determination part 1-1 on the inactive member, the remaining uncoated part, excluding the region adjacent to the position determination part 1-1, was cut and removed.

Subsequently, by referring to the position determination parts 2-1 through 2-4 on the inactive members, the boundaries between adjacent inactive members were cut (i.e., the sections connecting position determination parts 2-1 and 2-3, and position determination parts 2-2 and 2-4), preparing a third assembly including a single inactive member.

On the third assembly, an inactive member surrounded the side of the positive electrode layer, and the positive electrode layer was disposed so that the positive electrode layer was in contact with the solid electrolyte layer, thereby preparing a fourth assembly.

The inactive member includes an inner side disposed adjacent to a side of the positive electrode layer and an outer side opposing the inner side, and the position determination parts are disposed on the outer side.

The inactive member surrounding the side of the positive electrode layer includes a first side, a second side facing the first side, a third side disposed between the first side and the second side, and a fourth side facing the third side.

The inactive member had a first distance between the first inner side and the first outer side, a second distance between the second inner side and the second outer side, and a third distance between the third inner side and the third outer side, and a fourth distance between the fourth inner side and the fourth outer side.

The inactive member and the positive electrode layer included a first gap between the first side of the positive electrode layer and the first inner side of the inactive member, a second gap between the second side of the positive electrode layer and the second inner side of the inactive member, a third gap between the third side of the positive electrode layer and the third inner side of the inactive member, and a fourth gap between the fourth side of the positive electrode layer and the fourth inner side of the inactive member.

The positive electrode layer was disposed within the area defined by the first to fourth inner sides of the inactive member. The inactive member had a gasket shape surrounding the positive electrode layer and being spaced apart from the sides of the positive layers by the first to fourth gaps.

The area defined by the first to fourth outer sides of the inactive member was 110% of the area of the solid electrolyte layer. The area defined by the first to fourth inner sides of the inactive member was 90% of the area of the solid electrolyte layer.

The prepared fourth assembly was plate-pressed at 85° C., with a pressure of 500 MPa. This pressing process sintered the solid electrolyte layer, improving the battery characteristics. The thickness of the sintered solid electrolyte layer was about 45 μm. The density of the argyrodite-type crystalline Li₆PS₅Cl solid electrolyte included in the sintered solid electrolyte layer was 1.6 g/cc. The area of the solid electrolyte layer was the same as the area of the negative electrode layer, excluding the uncoated part.

A porous buffer pad was disposed on the negative electrode layer of the pressed fourth assembly to prepare a fifth assembly. The porous buffer pad was a porous polyacrylic foam sheet (YT-3720BHF, Youngwoo Co. Ltd., Korea).

The fifth assembly was placed in a pouch and vacuum-sealed to produce the mono-cell all solid secondary battery. Parts of the uncoated part of the positive and negative electrode layers were protruded outside the sealed battery to be used as positive and negative electrode terminals.

### Example 2: Bi-Cell All Solid Secondary Battery

### (Manufacturing of the Negative Electrode Layer)

The negative electrode layer was manufactured in the same way as in Example 1. Two negative electrode layers were prepared.

### (Manufacturing of the Positive Electrode Layer)

The positive electrode layer was manufactured in the same way as in Example 1, except that the positive electrode active material was formed on both sides of the positive electrode current collector.

The total thickness of the positive electrode layer was about 220 μm. The thickness of the positive electrode active material layer was about 96 μm, and the thickness of the carbon-coated aluminum foil was about 28 μm

### (Manufacturing of the Solid Electrolyte Layer)

The solid electrolyte layer was manufactured in the same way as in Example 1. Two solid electrolyte layers were prepared.

### (Manufacturing of the Flame-Retardant Inactive Member)

The flame-retardant inactive member was prepared in the same way as in Example 1.

### (Manufacturing of the all Solid Secondary Battery)

A third assembly was manufactured in the same manner as Example 1. Two third assemblies were prepared.

A fourth assembly was prepared by disposing the third assembly on both sides of the positive electrode layer so that the inactive member of the third assembly surrounded the side of the positive electrode layer and the solid electrolyte layer of the third assembly was in contact with the positive electrode layer.

The prepared fourth assembly was plate-pressed in the same manner as in Example 1 The area of the solid electrolyte layer was the same as that of the negative electrode layer, excluding the uncoated area.

A fifth assembly was prepared by disposing buffer pads on each of the two negative electrode layers of the pressurized fourth assembly. The porous buffer pads were porous polyacrylic foam sheets (YT-3720BHF, Youngwoo Co. Ltd., Korea).

The fifth assembly was placed in a pouch and vacuum sealed to manufacture a bi-cell all solid secondary battery. Parts of the positive electrode current collector and negative electrode current collector were protruded outside the sealed battery and used as the positive and the negative electrode layer terminals.

### Examples 3 to 9

A bi-cell all solid secondary battery was manufactured in the same manner as in Example 2, except that the number of position determination parts included in the inactive member, the size of the inactive member, or the size of the positive electrode layer was changed as shown in Table 1 below.

### Comparative Example 1

A bi-cell all solid secondary battery was manufactured in the same manner as in Example 2, except that no inactive member was applied as shown in Table 1 below

### Comparative Examples 2 to 4

Bi-cell all solid secondary batteries were manufactured in the same manner as in Example 2, except that inactive members without position determination parts were used, and the size of the inactive member or the size of the positive electrode layer was changed as shown in Table 1 below.

### (Manufacturing of the all Solid Secondary Battery Structure)

### Example 10

A plurality of pressurized fourth assembly manufactured in Example 2 were prepared.

A plurality of pressed fourth assembly were stacked in the thickness direction to prepare a fifth assembly. The fifth assembly corresponds to a battery stack (stack cell).

Porous buffer pads were disposed between adjacent pressed fourth assemblies included in the fifth assembly and at the topmost and bottommost layers of the fifth assembly, forming the sixth assembly. The same porous buffer pad as used in Example 2 was employed.

The sixth laminate was placed in a pouch, pressure vacuum-sealed to produce an all solid secondary battery structure.

TABLE 1

| | | Position | position | position | first | second | first | second |
|---|---|---|---|---|---|---|---|---|
| | Inactive | determination | determination | determination | distance | distance | gap | gap |
| | member | parts 1-1~1-2 | parts 2-1~2-4 | parts 3-1~3-4 | [μm] | [μm] | [μm] | [μm] |
| Example 2 | Applied | Applied | Applied | Applied | 3.2 | 2.3 | 0.5 | 0.5 |
| Example 3 | Applied | Applied | Applied | Applied | 3.2 | 2.3 | 0.3 | 0.3 |
| Example 4 | Applied | Applied | Applied | Applied | 3.2 | 2.3 | 0.2 | 0.2 |
| Example 5 | Applied | Applied | Applied | Applied | 3.2 | 2.3 | 0.1 | 0.1 |
| Example 6 | Applied | Applied | Applied | Applied | 3.2 | 2.3 | 0.0 | 0.0 |
| Example 7 | Applied | Applied | Applied | Unapplied | 3.2 | 2.3 | 0.1 | 0.1 |
| Example 8 | Applied | Applied | Unapplied | Unapplied | 3.2 | 2.3 | 0.1 | 0.1 |
| Example 9 | Applied | Applied | Applied | Applied | 2.0 | 2.0 | 0.1 | 0.1 |
| Comparative | Unapplied | — | — | — | — | — | — | — |
| Example 1 | | | | | | | | |
| Comparative | Applied | Unapplied | Unapplied | Unapplied | 3.2 | 2.3 | 0.2 | 0.2 |
| Example 2 | | | | | | | | |
| Comparative | Applied | Unapplied | Unapplied | Unapplied | 3.2 | 2.3 | 0.1 | 0.1 |
| Example 3 | | | | | | | | |
| Comparative | Applied | Unapplied | Unapplied | Unapplied | 3.2 | 2.3 | 0.0 | 0.0 |
| Example 4 | | | | | | | | |

### Evaluation Example 1: Charge-Discharge Characteristics Evaluation

The charge-discharge characteristics of the all solid secondary batteries manufactured in Examples 2 to 9 and Comparative Examples 1 to 4 were evaluated through the following charge-discharge test. The charge-discharge test was conducted by placing the all solid secondary batteries in a 45° C., thermostatic chamber.

In the first cycle, the batteries were charged with a constant current of 0.1 C until the voltage reached 4.25 V, followed by constant voltage charging at 4.25 V with a cut-off condition of 0.05 C. Subsequently, the batteries were discharged with a constant current of 0.1 C until the voltage reached 2.5 V.

From the second cycle onwards, charging and discharging were carried out under the same conditions as the first cycle up to 250 cycles. This means that the higher the number of cycles at which a short circuit occurs, the better the lifespan characteristics.

The evaluation results are shown in Table 2 below.

### Evaluation Example 2: Evaluation of Ease of Manufacturing the All Solid Secondary Battery

The ease of manufacturing the batteries was evaluated according to the following criteria.

During the process of manufacturing the all solid secondary battery by stacking the inactive member and the positive electrode layer on the solid electrolyte layer,

If it is difficult to accommodate the positive electrode layer within the inactive member, it is evaluated as x, if the accommodation is moderate, it is evaluated as Δ, and if the accommodation is easy, it is evaluated as ◯.

The evaluation results are shown in Table 2 below.

### Evaluation Example 3: Evaluation of Manufacturing Speed of the All Solid Secondary Battery

The manufacturing speed of the all solid secondary batteries manufactured in Examples 2 to 9 and Comparative Examples 1 to 4 was relatively evaluated.

A higher manufacturing speed indicates that the battery is manufactured in a shorter time, while a lower manufacturing speed indicates a longer manufacturing time.

The highest manufacturing speed was rated as 10, and the lowest as 1. For example, if it is difficult to align the inactive member on the solid electrolyte layer, the manufacturing speed decreased.

The evaluation results are shown in Table 2 below.

TABLE 2

| | Ease of | Battery | Cycle numbers at |
|---|---|---|---|
| | battery | manufacturing | short circuit |
| | manufacturing | speed | [times] |
| Example 2 | ◯ | 10 | 20 |
| Example 3 | ◯ | 9 | 45 |
| Example 4 | ◯ | 8 | 100 |
| Example 5 | Δ | 8 | 200 |
| Example 6 | X | 5 | 100 |
| Example 7 | X | 3 | 20 |
| Example 8 | X | 3 | 30 |
| Example 9 | Δ | 3 | 100 |
| Comparative | — | 10 | During the |
| Example 1 | | | first charge |
| Comparative | ◯ | 1 | During the |
| Example 2 | | | first charge |
| Comparative | Δ | 1 | During the |
| Example 3 | | | first charge |
| Comparative | X | 1 | During the |
| Example 4 | | | first charge |

As shown in Tables 1 and 2, the cycle characteristics of the all solid secondary batteries of Examples 2 to 9 were significantly improved compared to the all solid secondary batteries of Comparative Examples 1 to 4. The manufacturing speed of the all solid secondary batteries in Examples 2 to 5 was as high as that in Comparative Example 1, which did not use inactive members.

The ease of manufacturing for the all solid secondary batteries in Examples 2 to 5 was as excellent as that in Comparative Examples 2 to 3.

In Comparative Example 1, the all solid secondary battery did not include inactive members, resulting in a high manufacturing speed, but the cycle characteristics were poor due to the occurrence of cracks during the manufacturing process and/or during the charge-discharge cycles.

In Comparative Examples 2 to 4, the inactive members did not include position determination parts. Consequently, the battery manufacturing speed of the all solid secondary batteries of Comparative Examples 2 to 4 was significantly reduced due to the long time required to align the inactive members on the solid electrolyte layer.

After the first charge cycle of the all solid secondary batteries in Examples 1 to 9, SEM images of the cross-sections of these batteries were measured to confirm that a lithium metal precipitate layer was formed, which corresponds to the second negative electrode active material layer, between the first negative electrode active material layer and the negative electrode current collector.

As described above, the all solid secondary batteries related to these examples may be applied to various portable devices and vehicles.

While the illustrative embodiments have been described in detail with reference to the accompanying drawings, the present inventive concept is not limited to these examples. It is evident that various modifications and changes may be made by those skilled in the art within the scope of the technical idea described in the claims, and such modifications and changes are naturally within the technical scope of the present inventive concept.

### DESCRIPTION OF REFERENCE NUMERALS

1: ALL SOLID SECONDARY BATTERY
10: POSITIVE ELECTRODE LAYER
11: POSITIVE ELECTRODE CURRENT COLLECTOR
12: POSITIVE ELECTRODE ACTIVE MATERIAL LAYER
20: NEGATIVE ELECTRODE LAYER
21: NEGATIVE ELECTRODE CURRENT COLLECTOR
22: FIRST NEGATIVE ELECTRODE ACTIVE MATERIAL LAYER
30: SOLID ELECTROLYTE LAYER
40: INACTIVE MEMBER
100: ALL SOLID SECONDARY BATTERY STRUCTURE
110: BUFFERING PAD

### INDUSTRIAL APPLICABILITY

The new structure of the all solid secondary battery, equipped with position determination parts on the inactive members, allows for the easy manufacturing of all solid secondary batteries that prevent short circuits and exhibit improved cycle characteristics.

1. An all-solid secondary battery comprising:
a positive electrode layer; a negative electrode layer; and a solid electrolyte layer interposed between the positive electrode layer and the negative electrode layer,
wherein the positive electrode layer comprises a positive electrode current collector and a positive electrode active material layer disposed on one or both surfaces of the positive electrode current collector,
wherein the negative electrode layer comprises a negative electrode current collector and a first negative electrode active material layer disposed on the negative electrode current collector,
wherein the battery comprises an inactive member disposed to surround a side of the positive electrode layer,
wherein the inactive member comprises a position determination part configured to determine a position of the inactive member on the solid electrolyte layer.

2. The all-solid secondary battery of claim 1, wherein the inactive member comprises a first side, a second side opposite the first side, a third side disposed between the first side and the second side, and a fourth side opposite the third side,
wherein the position determination part comprises a position determination part 1-1 disposed on the first side,
wherein the positive electrode current collector comprises a positive electrode uncoated part extending outward from one side of the positive electrode layer, and the negative electrode current collector comprises a negative electrode uncoated part extending outward from one side of the negative electrode layer,
wherein the position determination part 1-1 is disposed on the positive electrode uncoated part or the negative electrode uncoated part.

3. The all-solid secondary battery of claim 2, wherein the position determination part further comprises a position determination part 1-2 disposed on the second side, and the position determination part 1-2 is disposed symmetrical to the position determination part 1-1,
wherein the position determination part 1-2 is disposed on the positive electrode uncoated part or the negative electrode uncoated part.

4. The all-solid secondary battery of claim 2, wherein the position determination part further comprises: a position determination part 2-1 disposed in an area where the first side and the third side are connected; and a position determination part 2-2 disposed in an area where the first side and the fourth side are connected,
wherein a length in a machine direction (MD) or a transverse direction (TD) of the inactive member is determined by the position determination part 2-1 and the position determination part 2-2.

5. The all-solid secondary battery of claim 2, wherein the position determination part further comprises: a position determination part 2-3 disposed in an area where the second side and the third side are connected; and a position determination part 2-4 disposed in an area where the second side and the fourth side are connected,
wherein a length in a machine direction (MD) or a transverse direction (TD) of the inactive member is determined by the position determination part 2-3 and the position determination part 2-4.

6. The all-solid secondary battery of claim 2, wherein the position determination part further comprises a position determination part 3-1 and a position determination part 3-2, which are disposed on the first side,
wherein the position determination part 3-1 is disposed between the position determination part 1-1 and the third side, and the position determination part 3-2 is disposed between the position determination part 1-1 and the fourth side,
wherein the position determination part 3-1 is disposed closer to the third side than is the position determination part 1-1, and the position determination part 3-2 is disposed closer to the fourth side than is the position determination part 1-1.

7. The all-solid secondary battery of claim 1, wherein the inactive member comprises: an inner side disposed adjacent to a side of the positive electrode layer; and an outer side opposite the inner side, and the position determination part is disposed on the outer side.

8. The all-solid secondary battery of claim 7, wherein the position determination part comprises a recessed part extending from the outer side toward the inner side, and the recessed part has a polygonal shape.

9. The all-solid secondary battery of claim 7, wherein the inactive member comprises:
a first inner side and a first outer side opposite the first inner side, the first inner side being disposed adjacent to a first side of the positive electrode layer, wherein there is a first distance between the first inner side and the first outer side;
a second inner side and a second outer side opposite the second inner side, the second inner side being adjacent to a second side of the positive electrode layer, wherein there is a second distance between the second inner side and the second outer side;
a third inner side and a third outer side opposite the third inner side, the third inner side being adjacent to a third side of the positive electrode layer, wherein there is a third distance between the third inner side and the third outer side; and
a fourth inner side and a fourth outer side opposite the fourth inner side, the fourth inner side being adjacent to a fourth side of the positive electrode layer, wherein there is a fourth distance between the fourth inner side and the fourth outer side;
wherein the first distance and the second distance are each independently 1% to 20% of a distance between the first outer side and the second outer side.

10. The all-solid secondary battery of claim 9, wherein the third distance and the fourth distance are each independently 1% to 30% of a distance between the third outer side and the fourth outer side.

11. The all-solid secondary battery of claim 9, wherein the inactive member and the positive electrode layer are at least partially spaced apart,
wherein the battery has a first gap between the first side of the positive electrode layer and the first inner side of the inactive member, the first gap being 1% to 99% of the first distance, or
the battery has a second gap between the second side of the positive electrode layer and the second inner side of the inactive member, the second gap being 1% to 99% of the second distance, or
the battery has a third gap between the third side of the positive electrode layer and the third inner side of the inactive member, the third gap being 1% to 99% of the third distance, or
the battery has a fourth gap between the fourth side of the positive electrode layer and the fourth inner side of the inactive member, the fourth gap being 1% to 99% of the fourth distance.

12. The all-solid secondary battery of claim 9, wherein the inactive member is disposed on a surface of the solid electrolyte layer,
wherein a first area defined by the first outer side to the fourth outer side of the inactive member is 101% to 150% of the area of the solid electrolyte layer, and
wherein a second area defined by the first inner side to the fourth inner side of the inactive member is 50% to 99% of the area of the solid electrolyte layer.

13. The all-solid secondary battery of claim 1,
wherein the positive electrode layer comprises a first positive electrode active material layer and a second positive electrode active material layer, each disposed on both surfaces of the positive electrode current collector,
wherein the solid electrolyte layer comprises a first solid electrolyte layer and a second solid electrolyte layer, each in contact with the first positive electrode active material layer and the second positive electrode active material layer, respectively,
wherein the negative electrode layer comprises a first negative electrode layer and a second negative electrode layer, each in contact with the first solid electrolyte layer and the second solid electrolyte layer, respectively,
wherein the inactive member is disposed to surround a side of the positive electrode layer between the first solid electrolyte layer and the second solid electrolyte layer opposing each other, and is separated from the first negative electrode layer and the second negative electrode layer.

14. The all-solid secondary battery of claim 1, wherein the inactive member is a flame-retardant inactive member, the flame-retardant inactive member comprising a matrix and a filler,
wherein the matrix comprises a substrate and a reinforcement material,
wherein the substrate comprises a first fibrous material, the first fibrous material being an insulating material, and the first fibrous material comprising at least one selected from pulp fibers, insulating polymer fibers, and ion-conductive polymer fibers,
wherein the reinforcement material comprises a second fibrous material, the second fibrous material being a flame-retardant material, and the second fibrous material comprising at least one selected from glass fibers and ceramic fibers,
wherein the filler is a moisture getter, and the filler comprises a metal hydroxide,
wherein the metal hydroxide comprises at least one selected from Mg(OH)₂, Fe(OH)₃, Sb(OH)₃, Sn(OH)₄, Ti(OH)₃, Zr(OH)₄, and Al(OH)₃.

15. The all-solid secondary battery of claim 1, wherein the solid electrolyte comprises a sulfide-based solid electrolyte,
wherein the sulfide-based solid electrolyte is at least one selected from Li₂S—P₂S₅, Li₂S—P₂S₅—LiX, wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn, wherein m and n are positive numbers, and Z is one of Ge, Zn, or Ga, Li₂S—GeS₂, Li₂S—SiS₂—Li₃PO₄, Li₂S—SiS₂—LiₚMO_{q}, wherein p and q are positive numbers, and M is one of P, Si, Ge, B, A1, Ga, In, Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2, or
the sulfide-based solid electrolyte is an argyrodite-type solid electrolyte comprising at least one selected from Li₆PS₅Cl, Li₆PS₅Br, and Li₆PS₅I,
wherein a density of the argyrodite-type solid electrolyte is 1.5 to 2.0 g/cc.

16. The all-solid secondary battery of claim 1, wherein the first negative electrode active material layer comprises a first negative electrode active material and a binder,
wherein the first negative electrode active material is in particulate form, with an average particle diameter of 4 μm or less,
wherein the first negative electrode active material comprises at least one selected from a carbon-based negative electrode active material and a metal or metalloid negative electrode active material,
wherein the carbon-based negative electrode active material comprises amorphous carbon,
wherein the metal or metalloid negative electrode active material is at least one selected from gold (Au), platinum (Pt), palladium (Pd), silicon (Si), silver (Ag), aluminum (A1), bismuth (Bi), tin (Sn), and zinc (Zn),
wherein the first negative electrode active material comprises a mixture of first particles consisting of amorphous carbon and second particles consisting of a metal or metalloid,
wherein the content of the second particles is 8 wt % to 60 wt %, based on a total weight of the mixture.

17. The all-solid secondary battery of claim 1, further comprising a second negative electrode active material layer disposed at least one of between the negative electrode current collector and the first negative electrode active material layer and between the solid electrolyte layer and the first negative electrode active material layer,
wherein the second negative electrode active material layer is a metal layer including lithium or a lithium alloy.

18. An all-solid secondary battery structure, comprising:
one or more of the all-solid secondary battery of claim 1; and
a buffering member disposed on one or both surfaces of the one or more of the all-solid secondary battery.

19. A method for manufacturing an all-solid secondary battery, comprising:
providing a first assembly comprising a solid electrolyte layer disposed on a negative electrode layer;
preparing a second assembly by aligning an inactive member reel in which a plurality of inactive members including position determination parts are connected on the solid electrolyte layer;
preparing a third assembly by cutting an uncoated part included in the negative electrode layer with reference to the position determination parts of the inactive member reel;
preparing a fourth assembly including one inactive member by cutting the third assembly with reference to the position determination parts of the inactive member; and
disposing the fourth assembly on one or both surfaces of the positive electrode layer such that the inactive member surrounds a side of the positive electrode layer.

20. The method for manufacturing an all-solid secondary battery of claim 19, further comprising introducing a position determination part to the inactive member reel.
